(19) United States
(12) Patent Application Publication
(10) Pub. No.: US 2023/0387548 A1
(43) Pub. Date: Nov. 30, 2023

(54) Heat/Flame-Resistant Polymer Composite-Based Solid Electrolyte Separator, Lithium Secondary Battery, and Manufacturing Method

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 17/804,721

(22) Filed: May 31, 2022

(51) Int. Cl. H01M 50/449; H01M 10/052; H01M 50/446; H01M 50/403; C08J 9/42; C08K 3/22; C08K 5/521

(52) U.S. Cl. CPC H01M 50/449; H01M 10/052; H01M 50/446; H01M 50/403; C08J 9/42; C08K 3/22; C08K 5/521; C08J 2379/06; C08J 2427/16; C08J 2427/20; C08K 2003/2227

(57) ABSTRACT

A flame-resistant composite separator for use in a lithium battery, wherein the composite separator comprises a porous layer of a first polymer, having pores and a thickness from 50 nm to 200 μm, and a second polymer permeating into or residing in the pores, wherein: (a) the first polymer comprises a flame-resistant polymer or thermally stable polymer; (b) the second polymer comprises a polymer that is polymerized and/or cured in situ in the pores or is a polymer solidified from a polymer solution inside the pores of the first polymer layer; and (c) the first polymer or the second polymer has a lithium-ion conductivity from 10⁻⁸ S/cm to 2×10⁻² S/cm at room temperature.

### FIELD

The present disclosure relates to the field of rechargeable lithium battery, including the lithium-ion battery and lithium metal battery (any rechargeable battery having lithium metal as the main anode active material), and, in particular, to an anode-less rechargeable lithium metal battery having no lithium metal as an anode active material initially when the battery is made and a method of manufacturing same.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li_{4.4}Si) as an anode active material. Hence, in general, rechargeable Li metal batteries have a significantly higher energy density than lithium-ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990's giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery,” U.S. Pat. No. 5,648,187 (Jul. 15, 1997); U.S. Pat. No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); U.S. Pat. No. 6,797,428 (Sept. 28, 2004); U.S. Pat. No. 6,936,381 (Aug. 30, 2005); and U.S. Pat. No. 7,247,408 (Jul. 24, 2007)] further proposed a multilayer anode structure consisting of a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, including at least 3 or 4 layers, is too complex and too costly to make and use.

Protective coatings for Li anodes, such as glassy surface layers of LiI- Li₃PO₄-P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); U.S. Pat. No. 7,282,296 (Oct. 16, 2007); and U.S. Pat. No. 7,282,302 (Oct. 16, 2007)].

Despite these earlier efforts, no rechargeable Li metal batteries have yet succeeded in the market place. This is likely due to the notion that these prior art approaches still have major deficiencies. For instance, in several cases, the anode or electrolyte structures are too complex. In others, the materials are too costly or the processes for making these materials are too laborious or difficult. Conventional solid electrolytes typically have a low lithium-ion conductivity, are difficult to produce and difficult to implement into a battery.

Furthermore, the conventional solid electrolyte, as a separator or as an anode-protecting layer (interposed between the lithium metal anode and a separator), does not have and cannot maintain a good contact with the lithium metal. This reduces the effectiveness of the electrolyte to support dissolution of lithium ions (during battery discharge), transport lithium ions, and allowing the lithium ions to re-deposit back to the lithium anode (during battery recharge). A ceramic separator that is disposed between an anode active material layer (e.g., a graphite-based anode layer) and a cathode active layer in a lithium-ion cell suffers from the same problems as well. In addition, a ceramic separator also has a poor contact with the cathode layer if the electrolyte in the cathode layer is a solid electrolyte (e.g., inorganic solid electrolyte).

Another major issue associated with the lithium metal anode is the constant reactions between liquid electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Hence, an object of the present disclosure was to provide an effective way to overcome the lithium metal dendrite and reaction problems in all types of Li metal batteries having a lithium metal anode. A specific object of the present disclosure was to provide a lithium cell (either lithium-ion cell or lithium metal cell) that exhibits a high specific capacity, high specific energy, high degree of safety, and a long and stable cycle life.

### SUMMARY

The present disclosure provides a flame-resistant polymer composite separator for use in a lithium battery, wherein the composite separator comprises a porous layer of a first polymer, having pores (pore volume from 10% to 99% by volume of the first polymer layer) and a thickness from 10 nm to 200 μm (preferably from 100 nm to 100 μm, more preferably less than 50 μm, and most preferably less than 20 μm) and a second polymer permeating into or residing in these pores of the first polymer layer, wherein: (a) the first polymer comprises a flame-resistant or thermally stable polymer (e.g. preferably those thermoplastic polymers that have a melting point or glass transition temperature greater than 250° C., preferably greater than 300° C., or those thermoset polymers having a thermal degradation temperature greater than 300° C., preferably greater than 350° C.); (b) the second polymer comprises either a polymer that is obtained by in situ polymerizing and/or curing a reactive mass in the pores or a polymer that is solidified or precipitated out from a polymer solution inside the pores of the first polymer layer; and (c) the first polymer or the second polymer has a lithium-ion conductivity no less than from 10⁻⁸ S/cm (preferably no less than 10⁻⁶ S/cm and typically from 10⁻⁵ S/cm to 2×10⁻² S/cm) when measured at room temperature.

The pores in the first polymer layer may comprise connected pores or through holes (through the thickness of the layer). The hole diameter is preferably from 500 nm to 5 mm, more preferably from 1 μm to 1 mm, and most preferably from 5 μm to 100 μm.

The flame-resistant or thermally stable polymer is preferably selected from the group consisting of epoxy, epoxy novolac, polyurethane, phenolic resin or phenol formaldehyde, polyester, vinyl ester resins, melamine resin, polyamide, polyamide-imide, bismaleimide, cyanate ester, silicone, polyurea-urethane, Diallyl-phthalate, benzoxazines, polyimide, poly(amide imide), poly(ether imide), aromatic polyamide, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenyiene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1 3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod polymers, ladder polymers, sulfonated versions thereof, copolymers thereof, interpenetrating networks thereof, and combinations thereof.

In certain preferred embodiments, (a) the first polymer further comprises 60%-99% by volume of inorganic material particles or fibers, 1-50% by weight of a lithium salt, and/or1-50% by weight of a flame-retardant additive dispersed or dissolved in the first polymer; and/or (b) the second polymer further comprises 60%-99% by volume of inorganic material particles or fibers, 1-50% by weight of a lithium salt, and/ort-50% by weight of a flame-retardant additive dispersed or dissolved in the second polymer.

In certain embodiments, the inorganic material particles in the first polymer or the second polymer comprise an inorganic solid electrolyte material selected from an oxide type, sulfide type, hydride type, halide type, borate type, phosphate type, lithium phosphorus oxynitride (LiPON) type, Garnet-type, lithium superionic conductor (LISICON) type, sodium superionic conductor (NASICON) type electrolyte, or a combination thereof.

In some embodiments, the inorganic material particles in the first polymer or the second polymer comprise a material selected from a transition metal oxide, aluminum oxide, silicon dioxide, transition metal sulfide, transition metal selenide, alkylated ceramic particles, metal phosphate, metal carbonate, or a combination thereof, or the inorganic material fibers are selected from ceramic fibers, glass fibers, or a combination thereof.

The second polymer is preferably produced by curing (polymerizing and/or crosslinking) a reactive mass that contains a polymerizable liquid solvent (herein referred to as the first liquid solvent) selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3,5-trioxane (TXE), 1,3- acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, tetrahydrofuran, combinations thereof, and combinations thereof with phosphates, phosphonates, phosphinates, phosphines, phosphine oxides, phosphonie acids, phosphorous acid, phosphites, phosphoric acids, phosphazene compounds, ionic liquids, derivatives thereof, and mixtures thereof.

In some embodiments, the first polymer is preferably produced from a thermosetting or cross-linkable material. Examples of thermosetting resins or polymers that can be crosslinked are epoxy, epoxy novolac, polyurethane, phenolic resin (or phenol formaldehyde), polyimide, polyether imide, polyester, vinyl ester, polyamide, polyamide-imide, melamine resin, bismaleimide, cyanate ester, silicone, polyurea-urethane, Diallyl-phthalate, benzoxazines, ladder polymers, copolymers thereof, interpenetrating networks thereof, and combinations thereof.

In some embodiments, the first polymer is selected from the group consisting essentially of polyacrylonitriles, polyamides, polyimides, polyethylene terephthalate, polybutylene tere,phthalate,, polysulfone, polyvinyl fluoride, polyvinyliclene fluoride, polyvinyliclene fluoride-hexafluoropropylent, polymethyl pentene, polyphenylene sulfide, polyacetyl, polyurethane, aromatic polyamide, semi-aromatic polyamide, polypropylene terephthalate, polymethyl methacrylate, synthetic cellulosic polymers, polyaramids, rigid-rod polymers, ladder polymers, and blends, mixtures and copolymers thereof.

In some embodiments, the second polymer comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The lithium salt may be selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y =1-4.

In certain embodiments, the second polymer of the flame-resistant composite separator further comprises a flame retardant additive dispersed therein. The flame retardant additive may be selected from a halogenated flame retardant, phosphorus--based flame retardant, melamine flame retardant, metal hydroxide flame retardant, silicon-based flame retardant, phosphate flame retardant, biomolecular flame retardant, or a combination thereof.

In certain embodiments, the composite separator further comprises a non-flammable liquid solvent that permeates into at least the second polymer of the separator. This non-flammable liquid solvent may be herein referred to as a second liquid solvent if the second polymer is synthesized in situ from a first liquid solvent that is polymerizable and/or crosslinkable. Typically, this second liquid solvent has a higher flash point or lower vapor pressure as compared to the first liquid solvent (or the liquid solvent that is polymerized to become the second polymer). Such a second liquid solvent is capable of improving the lithium-ion conductivity and/or flame-retardancy of the composite separator and of the battery cell.

The second liquid solvent may be selected from the group consisting of fluoroethylene carbonate, vinyl sulfite, vinyl ethylene sulfite, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, tetrahydrofuran, combinations thereof, and combinations thereof with phosphates, phosphonates, phosphinates, phosphines, phosphine oxides, phosphonic acids, phosphorous acid, phosphites, phosphoric acids, phosphazene compounds, ionic liquids, derivatives thereof, and mixtures thereof.

The first or the second liquid solvent may comprise a sulfone or sulfide selected from vinyl sulfone, allyl sulfone, alkyl vinyl sulfone, aryl vinyl sulfone, vinyl sulfide, TrMS, MTrMS, TMS, EMS, MMES, EMES, EMEES, or a combination thereof:

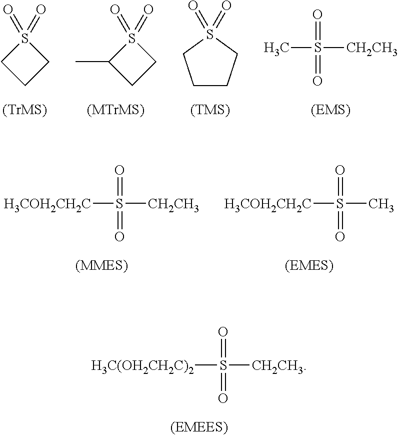

The the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof.

The first or the second liquid solvent may alternatively comprise a nitrile, a dinitrile selected from AND, GLN, SEN, succinonitrile (SN), or a combination thereof, wherein AND, GLN, SEN, respectively, have the following chemical formula:

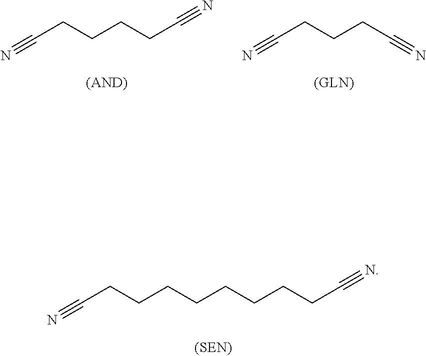 [SMILES: N#CCCCCC#N ; N#CCCCC#N ; N#CCCCCCCCCC#N]

In certain embodiments, the second liquid solvent comprises a phosphate selected from allyl-type, vinyl-type, styrenic-type and (meth)acrylic-type monomers bearing a phosphonate moiety.

In certain embodiments, the first liquid solvent or the second liquid solvent is selected from the group consisting of 2-alkoxy (or phenoxy)-2-oxo-1,3,2-dioxaphospholane (I) and 2-alkoxy (or phenoxy)-2-oxo-1,3,2-dioxaphosphorinane (II), derivatives thereof, and combinations thereof:

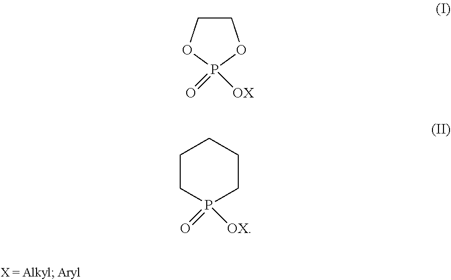

The first liquid solvent or the second liquid solvent may be chosen to comprise phosphate, phosphonate, phosphonic acid, or phosphite selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TDP, DPOF, DMMP, and DMMEMP have the following chemical formulae:

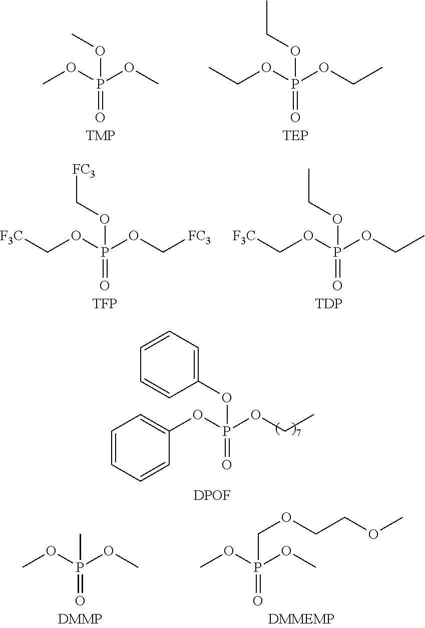

wherein an end group thereof or a functional group attached thereof comprises unsaturation for polymerization.

In some embodiments, the first liquid solvent or the second liquid solvent comprises phosphonate vinyl monomer selected from the group consisting of phosphonate bearing allyl monomers, phosphonate bearing vinyl monomers, phosphonate bearing styrenic monomers, phosphonate bearing (meth)acrylic monomers, vinylphosphonic acids, and combinations thereof. The phosphonate bearing allyl monomer may be selected from a Dialkyl allylphosphonate monomer or Dioxaphosphorinane allyl monomer; the phosphonate bearing vinyl monomers is selected from a Dialkyl vinyl phosphonate monomer or Dialkyl vinyl ether phosphonate monomer; the phosphonate bearing styrenic monomer is selected from α-, β-, or p-vinylbenzyl phosphonate monomers; or the phosphonate bearing (meth)acrylic monomer is selected from a monomer having a phosphonate group linked to the acrylate double bond, a phosphonate groups linked to the ester, or a phosphonate groups linked to the amide.

The first or the second solvent may be cured (polymerized and/or crosslinked) using an initiator and/or a curing agent, if so desired.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule. The crosslinking agent may be selected from poly(diethanol) diacrylate, polytethyleneglycol)dimethacrylate, poly(diethanol) dimethylacrylate, poly(ethylene glycol) diacrylate, or a combination thereof.

The initiator may be selected from an azo compound, azobisisobutyronitrile, azobisisoheptonitrile, dimethyl azobisisobutyrate, benzoyl peroxide tert-butyl peroxide and. methyl ethyl ketone peroxide, benzoyl peroxide (BPO), bis(4-tert-butylcyclohexyl) peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The present disclosure also provides a lithium secondary battery comprising a cathode, an anode, and the aforementioned flame-resistant polymer composite separator, which is disposed between the cathode and the anode. Typically, this anode/separator/cathode assembly is protected by a casing or package.

In certain embodiments, the anode in the lithium secondary battery has an amount of lithium or lithium alloy as an anode active material supported by an anode current collector. In certain other embodiments, initially the anode has no lithium or lithium alloy as an anode active material supported by the anode current collector when the battery is made and prior to a charge or discharge operation of the battery. This latter configuration is referred to as an anode-less lithium battery. During the first battery charge operation, lithium ions come out of the cathode active material, move to the anode, and deposit onto a surface of the anode current collector.

In certain embodiments, the battery is a lithium-ion battery and the anode has an anode current collector and a layer of an anode active material supported by the anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo2O₄; (f) carbon or graphite particles (g) prelithiated versions thereof; and (h) combinations thereof.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

Preferably, the inorganic material comprises an inorganic solid electrolyte material (dispersed in the polymer composite separator layer) that is in a fine powder form having a particle size preferably from 10 nm to 30 μm, more preferably from 50 nm to 1 μm. The inorganic solid electrolyte material may be selected from an oxide type, sulfide type, hydride type, halide type, borate type, phosphate type, lithium phosphorus oxynitride (LiPON), Garnet-type, lithium superionic conductor (LISICON), sodium superionic conductor (NASICON), or a combination thereof. These solid electrolyte particles can improve the lithium-ion transport rates of the composite separator.

The polymer composite separator preferably has a lithium-ion conductivity no less than 10⁻⁵ S/cm, more preferably no less than 10⁻⁴ S/cm, and most preferably no less than 10⁻³ S/cm.

In some embodiments, the inorganic material particles comprise a material selected from a transition metal oxide (e.g., TiO₂), aluminum oxide, silicon dioxide, transition metal sulfide, transition metal selenide, alkylated ceramic particles, metal phosphate, metal carbonate, or a combination thereof. These particles act to stop the penetration of any potential lithium dendrite that otherwise could cause internal shorting.

In some embodiments, this polymer composite layer may be a thin film disposed against a surface of an anode current collector. The anode contains a current collector without a lithium metal or any other anode active material, such as graphite or Si particles, when the battery cell is manufactured. Such a battery cell having an initially lithium metal-free anode is commonly referred to as an “anode-less” lithium battery. The lithium ions that are required for shuttling back and forth between the anode and the cathode are initially stored in the cathode active materials (e.g., Li in LiMn₂O₄ and LiMPO₄, where M=Ni, Co, F, Mn, etc.). During the first battery charge procedure, lithium ions (Lit) come out of the cathode active material, move through the electrolyte and then through the presently disclosed protective high-elasticity polymer layer and get deposited on a surface of the anode current collector. As this charging procedure continues, more lithium ions get deposited onto the current collector surface, eventually forming a lithium metal film or coating.

In certain embodiments, the polymer further contains a reinforcement material dispersed therein wherein the reinforcement material is selected from a polymer fiber, a glass fiber, a ceramic fiber or nano-flake (e.g., nano clay flakes), or a combination thereof. The reinforcement material preferably has a thickness or diameter less than 100 nm.

In certain preferred embodiments, the cathode active material in a lithium-ion cell or a lithium metal cell may be mixed with a working electrolyte referred to as a catholyte. The anode active material in a lithium-ion cell may be mixed with a working electrolyte referred to as an anolyte. The working electrolyte in the lithium battery may be selected from an organic liquid electrolyte (viable but not preferred), ionic liquid electrolyte, polymer gel electrolyte, solid polymer electrolyte, inorganic solid-state electrolyte, quasi-solid electrolyte having a lithium salt dissolved in an organic or ionic liquid with a lithium salt concentration higher than 2.0 M, or a combination thereof.

The cathode active material may be selected from an inorganic material, an organic material, a polymeric material, or a combination thereof. The inorganic material may be selected from a metal oxide, metal phosphate, metal silicide, metal selenide (e.g., lithium polyselides for use in a Li-Se cell), metal sulfide (e.g., lithium polysulfide for use in a Li-S cell), or a combination thereof. Preferably, these cathode active materials contain lithium in their structures; otherwise, the cathode should contain a lithium source.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The cathode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the cathode active material has a dimension less than 50 nm, even more preferably less than 20 nm, and most preferably less than 10 nm. In some embodiments, one particle or a cluster of particles may be coated with or embraced by a layer of carbon disposed between the particle(s) and/or a high-elasticity polymer layer (an encapsulating shell).

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, which is selected from a carbon material, graphene, electronically conductive polymer, conductive metal oxide, or conductive metal coating.

The disclosure also provides a process for manufacturing the polymer composite separator described above, the process comprising: (a) providing a porous layer of the first polymer having pores (preferably comprising connected pores or through holes, which are pores that run through a thickness) of the porous layer; (b) impregnating the pores or holes with a reactive mass or a polymer solution wherein the reactive mass comprises a monomer (e.g., the first liquid solvent that is polymerizable) and an initiator or an oligomer and a curing agent, or wherein the polymer solution comprises the second polymer dissolved in a liquid solvent; and (c) forming the second polymer by in situ polymerizing and/or curing the reactive mass in the pores or by removing the solvent from the polymer solution to solidify or precipitate our the second polymer inside the pores of the first polymer layer.

Preferably, the reactive mass comprises a first solvent that is polymerizable or crosslinkable inside pores of the first polymer layer. The first solvent may be selected from the group consisting of vinylene carbonate, ethylene carbonate, fluoroethylene carbonate. vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, tetrahydrofuran, phosphates, phosphonates, phosphinates, phosphines, phosphine oxides, phosphonic acids, phosphorous acid, phosphites, phosphoric acids, phosphazene compounds, ionic liquids. derivatives thereof, and mixtures thereof.

In some embodiments, step (a) and step (b) are conducted inside a battery cell after the porous layer of the first polymer is combined with an anode and a cathode to form the cell.

In certain embodiments, the process further comprises a step (d) of impregnating a second liquid solvent, containing a lithium salt dispersed or dissolved therein, into the pores or holes of the porous first polymer layer.

Preferably, the process comprises a roll-to-roll procedure wherein step (a) and (b) comprise (i) continuously feeding a layer of the porous first polymer layer from a feeder roller to a dispensing zone where the reactive mass or the polymer solution is dispensed and deposited onto said porous first polymer layer, allowing the reactive mass or the polymer solution to permeate into the pores; and step (c) comprises (ii) moving the reactive mass-or polymer solution-impregnated porous polymer layer into a reacting zone or solidification zone where the reactive mass is exposed to heat, ultraviolet light, or high-energy radiation to initiate the polymerization or curing procedure, or wherein the solvent in the polymer solution is removed, to form a continuous layer of polymer composite comprising both the first polymer and the second polymer; and wherein the process further comprises (iii) collecting said polymer composite on a winding roller.

It may be noted again that the procedure of curing (polymerizing and/or crosslinking) the first solvent may be conducted before or after the separator is combined with an anode and a cathode to form a battery cell.

In certain preferred embodiments, the porous first polymer layer coming out of a winding roller, may be supported on a solid substrate, which may be an anode current collector, an anode active material layer, or a cathode active material layer. In other words, this polymer composite separator can be directly deposited onto a layer of anode active material, an anode current collector, or a layer of cathode active material. This is achievable because curing of the polymer does not require a high temperature; curing temperature being typically lower than 300° C. or even lower than 100° C.

This procedure of exposing the reactive mass to an energy source (heat, UV, electron beam, Gramma radiation, etc.) to get the curing reactions initiated is helpful if this composite layer will be soon incorporated into a battery cell. This early start would reduce the required time to complete the polymerization and/or crosslinking reactions. If this reactive composite layer is to be stored for some time, this energy exposure procedure may be preferably conducted after the battery cell is made to activate and complete the in situ curing procedure.

The process may further comprise cutting and trimming the layer of polymer composite into one or multiple pieces of polymer composite separators.

The process may further comprise a step of combining an anode, the polymer composite separator, an electrolyte, and a cathode electrode to form a lithium battery.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently invented lithium metal battery cell (upper diagram) containing an anode current collector (e.g., Cu foil) but no anode active material (when the cell is manufactured or in a fully discharged state), a polymer composite separator, and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the polymer composite separator when the battery is in a charged state.

FIG. 3(A) Schematic of a polymer composite separator layer containing interconnected pores to accommodate the second polymer or its precursor according to some embodiments of the present disclosure;

FIG. 3(B) Schematic of a polymer composite separator layer containing through holes to accommodate the second polymer or its precursor according to some embodiments of the present disclosure.

FIG. 4 A flowchart illustrating a process for producing a polymer composite separator according to some embodiments of the present disclosure.

FIG. 5 Schematic of a roll-to-roll process for producing rolls of polymer composite separator in a continuous manner according to some embodiments of the present disclosure.

### DETAILED DESCRIPTION

This disclosure is related to a lithium secondary battery. The anode and the cathode are separated by a flame-resisting, thermally stable polymer composite-based solid-state electrolyte separator. The shape of a lithium secondary battery can be cylindrical, square, button-like, etc. The present invention is not limited to any battery shape or configuration or any type of electrolyte. Preferably, there is a working electrolyte in the anode (anolyte) and/or the cathode (catholyte). This working electrolyte may be selected from an organic electrolyte, a polymer gel electrolyte, a solid polymer electrolyte, an ionic liquid electrolyte, a quasi-solid electrolyte, or an inorganic solid-state electrolyte. This working electrolyte, in contact with a cathode active material, is referred to as a catholyte, for instance.

The present disclosure provides a flame-resistant polymer composite electrolyte/separator for use in a lithium battery, wherein the composite separator comprises a porous layer of a first polymer, having pores (10%-99% by volume of pores, preferably 30%-90% by volume) and a thickness from 10 nm to 200 μm (preferably from 100 nm to 100 μm, more preferably less than 50 μm, and most preferably less than 20 μm) and a second polymer permeating into or residing in these pores of the first polymer layer, wherein: (a) the first polymer comprises a flame-resistant or thermally stable polymer (e.g. preferably those thermoplastic polymers that have a melting point or glass transition temperature greater than 250° C., preferably greater than 300° C., or those thermoset polymers having a thermal degradation temperature greater than 300° C., preferably greater than 350° C.); (b) the second polymer comprises either a polymer that is obtained by in situ polymerizing and/or curing a reactive mass in the pores or a polymer that is solidified or precipitated out from a polymer solution inside the pores of the first polymer layer; and (c) the first polymer or the second polymer has a lithium-ion conductivity no less than from 10⁻⁸ S/cm (preferably no less than 10⁻⁶ S/cm and typically from 10⁻⁵ S/cm to 2×10⁻² S/cm) when measured at room temperature.

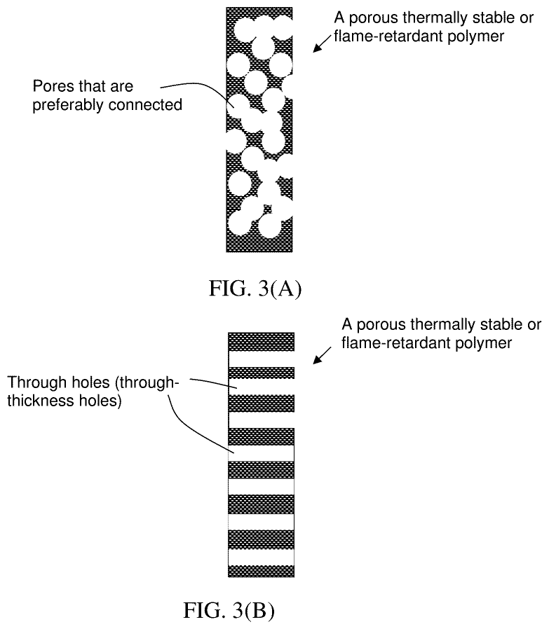

As schematically shown in FIG. 3(A), the first polymer layer preferably contains interconnected pores. Alternatively, as schematically shown in FIG. 3(B), the first polymer layer contains through holes (holes running through the thickness of the layer).

The flame-resistant or thermally stable polymer (the first polymer) is preferably selected from the group consisting of epoxy, epoxy novolac, polyurethane, phenolic resin or phenol formaldehyde, polyester, vinyl ester resins, melamine resin, polyamide, polyamide-imide, bismaleimide, cyanate ester, silicone, polyurea-urethane, Diallyl-phthalate, benzoxazines, polyimide, poly(amide imide), poly(ether imide), aromatic polyamide, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1, 3,4-oxadiazoles), poly(1,2,4-oxa-diazoles), poly(1,2,4- and I ,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod polymers, ladder polymers, sulfonated versions thereof, copolymers thereof, interpenetrating networks thereof, and combinations thereof.

In certain preferred embodiments, (a) the first polymer further comprises 60%-99% by volume of inorganic material particles or fibers, 1-50% by weight of a lithium salt, and/or 1-50% by weight of a flame-retardant additive dispersed or dissolved in the first polymer; and/or (b) the second polymer, residing in pores of the first polymer layer, further comprises 60%-99% by volume of inorganic material particles or fibers, 1-50% by weight of a lithium salt, and/or 1-50% by weight of a flame-retardant additive dispersed or dissolved in the second polymer.

The inorganic material particles in the first polymer or the second polymer may comprise an inorganic solid electrolyte material selected from an oxide type, sulfide type, hydride type, halide type, borate type, phosphate type, lithium phosphorus oxynitride (UPON) type, Garnet-type, lithium supertonic conductor (LISICON) type, sodium superionic conductor (NAS ICON) type electrolyte, or a combination thereof.

Alternatively, the inorganic material particles comprise a material selected from a transition metal oxide, aluminum oxide, silicon dioxide, transition metal sulfide, transition metal selenide, alkylated ceramic particles, metal phosphate, metal carbonate, or a combination thereof.

This polymer composite separator may be used in a lithium cell wherein, in a typical configuration, the separator is in ionic contact with both the anode and the cathode of the battery cell and typically in physical contact with an anode active material layer (or an anode current collector) and with a cathode active material layer.

The second polymer is preferably produced by curing (polymerizing and/or crosslinking) a polymerizable liquid solvent (herein referred to as the first liquid solvent) selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl su.lfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, tetrahydrofuran, combinations thereof, and combinations thereof with phosphates, phosphonates, phosphinates, phosphines, phosphine oxides, phosphonic acids, phosphorous acid, phosphites, phosphoric acids, phosphazene compounds, ionic liquids, derivatives thereof, and mixtures thereof.

These polymerizable liquid solvents (monomers or curable oligomers) can be impregnated into the pores of the first polymer layer and optionally also into the anode and the cathode layers of a battery cell and then cured (polymerized and/or crosslinked). The impregnation of these polymerizable liquid solvents into the pores of the first polymer layer can occur before or after the lithium battery cell is made. The polymerization and/or crosslinking also can get initiated before the lithium battery cell is made, and then completed afterward.

The first polymer may be produced from a thermosetting or cross-linkable material. Examples of thermosetting resins or polymers that can be crosslinked are epoxy, epoxy novolac, phenolic resin (or phenol formaldehyde), polyester, vinyl ester, melamine resin, bismaleimide, cyanate ester, copolymers thereof, interpenetrating networks thereof, and combinations thereof.

However, preferably, the first polymer is a thermally stable or high-temperature polymer selected from the group consisting of polyimide, poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, bibenzimidazold poly(arylene ethers), polycarboranes, poly (p-xylylene), poly(phenylene ether), polymers from 1,4,5,8-naphthalenetetracarboxylic acid and aromatic tetraamines, poly(1, 3,4-oxadiazoles), poly(1,2,4-oxa-diazoles), poly(1,24- and 1,2,5-oxadiazole-N-oxides), polythiadiazoles, polypyromellitimidlnes, poly-1,3,4-thiazidazoie, poly(benzimidazo-benzophenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof. Sulfonation is herein found to impart improved lithium-ion conductivity to a polymer.

Several examples of thermally stable polymers will be briefly discussed in what follows: Polyimide (PI) is a polymer of imide monomers belonging to the class of thermally stable polymers. A classic polyimide is Kapton, which is produced by condensation of pyromellitic dianhydride and 4,4′-oxydianiline. Polyimides exist in two formats: thermosetting and thermoplastic. Depending upon the constitution of their main chain, polyimide can be classified as aliphatic, aromatics, semi-aromatics. Pis can be thermoplastics or thermosets. Aromatic polyimides are derived from an aromatic dianhydride and diamine.

Semi-aromatic PIs contain any one of the monomer aromatics: i.e., either the dianhydride or diamine is aromatic, and the other part is aliphatic. Aliphatic polyimides consist of the polymers formed as a result of the combination of aliphatic dianhydride and diamine. Some examples of PI structures are given below:

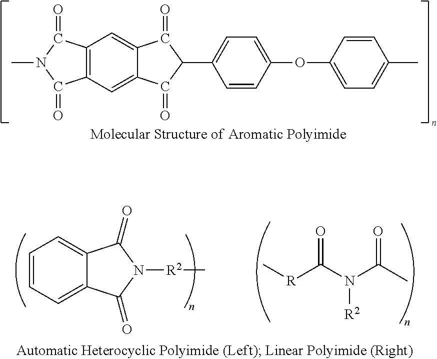

Several methods can be used to prepare polyimides; e.g., (i) the reaction between a dianhydride and a diamine (the most used method) and (ii) the reaction between a dianhydride and a diisocyanate. The desired lithium salt may be added into either or both the reactants, or the resultant oligomers. One may also add the lithium salt into the intermediate poly(amid acid).

The polymerization of a diamine and a dianhydride can be conducted by a two-step method in which a poly(amid acid) is prepared first or directly by a one-step method. The two-step method is the most widely used procedure for polyimide synthesis. At first a soluble poly(amic acid) is prepared which is cyclized after further processing in a second step to the polyimide. A two-step process is necessary because the final polyimides are in most cases infusible and insoluble due to their aromatic structure.

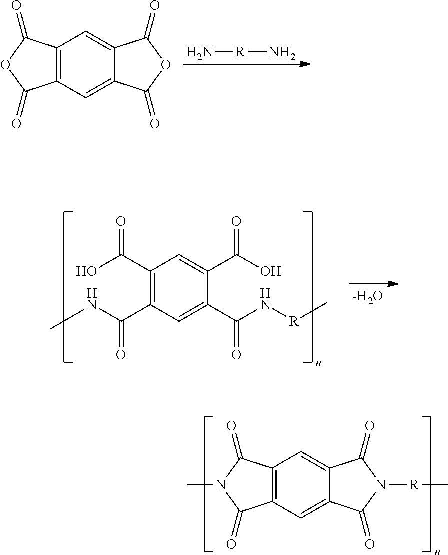

Dianhydrides used as precursors to these materials include pyromellitic dianhydride, benzoquinonetetracarboxylic dianhydride and naphthalene tetracarboxylic dianhydride. Common diamine building blocks include 4,4′-diaminodiphenyl ether (“DAPE”), meta-phenylene diamine (“MDA”), and 3,3-diaminodiphenylmethane. Hundreds of diamines and dianhydrides have been examined to tune the physical and especially the processing properties of Pis. These materials tend to be insoluble and have high softening temperatures, arising from charge-transfer interactions between the planar subunits

Highly soluble phenylethynyl-endcapped isoimide oligomers can be synthesized using 2,3,3′,4′-biphenyltetracarboxylic dianhydride (3,4′-BPDA) and aromatic diamines as the monomers, 4-phenylethynyl phthalic anhydride (4-PEPA) as the end-capping reagent, and trifluoroacetic anhydride as the dehydrating agent. Subsequently, thermosetting polyimides and PI composites can be produced from these oligomers via the thermal crosslinking reaction of the phenylethylnyl group. The composite separator layers may be produced by adding a desired amount of inorganic filler (e.g., SiO₂ nano particles or particles of a solid inorganic electrolyte) in the oligomer.

For instance, a series of isoimide oligomers with different molecular weights and a variety of chemical architectures can be prepared by polycondensation of 3,4′-BPDA, 4-PEPA, and aromatic diamines including rn-phenylenediamine (rn-PDA), 2,2′-bis(trifluoromethyl) benzidine (TFMB), and 3,4′-oxydianiline (3,4′-ODA), followed by cyclization with trifluoroacetic anhydride. Compared to their imide analogues, isoimide oligomers can exhibit much higher solubility in low boiling point solvents, and slightly lower melt viscosity. These resins can be formulated into thermosetting polyimides and composites by thermal crosslinking of the phenylethynyl group and conversion from isoimide to imide at elevated temperatures. The cured polyimides can exhibit extremely high glass transition temperatures (T_{g}) up to 467° C., and 5% weight loss temperatures (T_{5%}) up to 584° C. in a nitrogen atmosphere. The polyimide-inorganic filler composites can possess high glass transition temperatures and thermal stability.

Poly[2,2′-(m-phenylene)-5,5′-bibenzimidazole] (PBI) is a thermally stable polymer synthesized from tetra-aminobiphenyl-(3,3′-diaminobenzidine) and diphenyl isophthalate. It is used in different forms, such as fibers, composites, and neat resin, primarily for high-temperature applications. PBI has excellent dimensional stability at high temperatures, and it emits very little smoke when it is exposed to extremely high temperatures. This feature is particularly helpful for lithium battery applications. It is resistant to chemicals, and it retains its integrity even when charred.

Polyquinolines are versatile, thermally stable polymers and are characterized by repeating quinoline units, which display a catenation pattern of 2,6, 2,4, or 3,6 units. Polyquinolines are formed by the step-growth polymerization of o-aminophenyl ketone monomers and ketone monomers containing a hydrogens (mostly acetophenone derivatives):

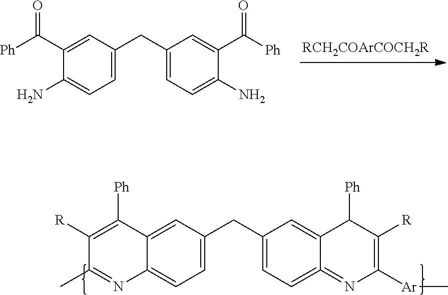

Alternatively, they may be prepared by the Friedlander reaction , which involves either an acid- or a base-catalyzed condensation of an o-aminoaromatic aldehyde or ketone with a ketomethylene compound. Polyquinolines have also been obtained by a postpolymerization thermal treatment of poly(enaminonitriles). The resulting polymers show excellent thermal stability, with initial weight losses occurring between 500° C. and 600° C. in air.

Polyimide is an important thermally stable polymer. Wide variations of the monomers and the precursors make polyimide a suitable candidate to be used as one component of a polymer alloy. For instance, polymer alloys of a polybenzoxazine and a polyimide was prepared by blending B-a (see the figure below) as a benzoxazine with a poly(amide acid), PAA, as a precursor of polyimide, followed by film casting and thermal treatment for the ring-opening polymerization of the benzoxazine and imidization.

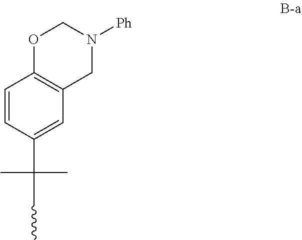

Various types of PAA were prepared as shown in the below figure:

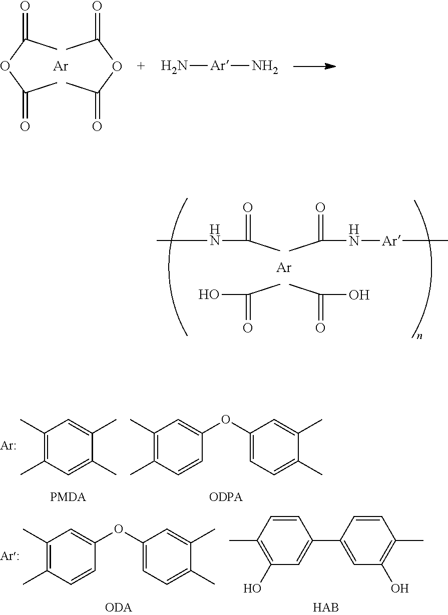

The onset temperature of the exotherm due to the ring-opening polymerization can decrease by as much as ˜80 ° C. by blending B-a with a PAA because of the catalytic effect of the carboxylic group in the PAA. The resulting alloy films are considered to form a semi-interpenetrating polymer network (semi-IPN) consisting of a linear polyimide and a crosslinked polybenzoxazine or to form an AB-co-crosslinked polymer network by the copolymerization of benzoxazine with polyimide containing a pendent phenolic hydroxyl:

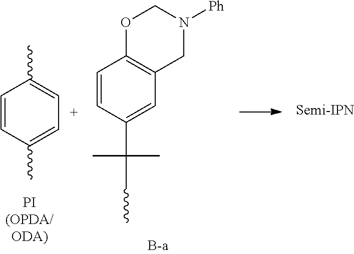

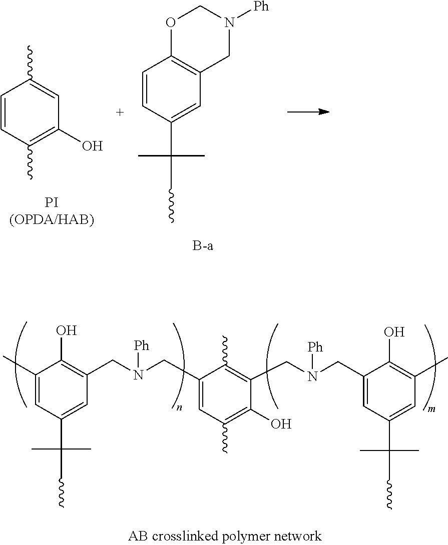

The semi-IPN polymers gave two T_{g}s, while the AB-co-crosslinked polymers gave only one T_{g}. Both types of polymer alloys were effective to improve the brittleness, the T_{g} and the thermal degradation temperature of polybenzoxazine. The semi-IPN formation was especially effective for toughening the polybenzoxazine, while the AB-co-crosslinked polymer network was effective for increasing T_{g}.

Another type of thermally stable polymers is polyphthalonitrile resins. Intensive investigations on high-temperature polymers have led to the development of a broad array of thermooxidatively stable materials. Phthalonitrile resins are an addition to this unique class of addition-curable, high-temperature polymeric material. Structural modifications through the incorporation of thermally stable groups such as fluorine, imide, and benzoxazine enable the development of resin systems with tunable properties. The structure-property relationship in these polymers, the role of different curatives, the processability, and the corresponding cross-linking mechanisms have been studied. The scenario of self-cure-promoting phthalonitriles has been proposed that would accelerate the long cure schedule required to attain the complete nitrile curing.

Polycondensations of 1,4,5,8-naphthalenetetracarboxylic acid (NTCA) with both 3,3′-diaminobenzidine (DAB) and 1,2,4,5-tetraaminobenzene tetrahydrochloride (TAB) in polyphosphoric acid (PPA) were found to produce soluble polymers which exhibit excellent thermal stabilities. The solubility in certain solvents is a good feature in the production of polymer matrix composite separator layers. Polymer derived from TAB had a ladder-type structure. Polymers with solution viscosities near 1 or above (determined in H₂SO₄) can be obtained from polymerizations near 200° C., and analysis showed these to possess a very high degree of completely cyclized benzimidazo-benzophenanthroline structure. Less vigorous reaction conditions gave polymers with lower solution viscosities which appeared to be less highly cyclized. Low-viscosity polymer can be prepared from DAB and NTCA by solid-phase polycondensation. Some advancements in the solution viscosities of polymers synthesized from DAB in PPA were caused by second staging in the solid phase.

Another useful class of thermally stable polymers is the ladder polymers. The synthesis of ladder polymers has been performed via Diels-Alder reactions, and based on Tröger's base formation and double aromatic nucleophilic substitution. Many of the synthetic methods result in relatively flexible linkages in polymer backbones except for Tröger's base linkage. Rigid ladder polymers may be synthesized by palladium or nickel-catalyzed annulation (Yan Xia, et al, “Efficient synthesis of rigid ladder polymers,” U.S. Pat. No. 9,708,443, Jul. 18, 2017),

There are a wide variety of rigid-rod and ladder polymers that can be used as a thermally stable polymer in the disclosed polymer composite separators. These thermally stable polymers have a high thermo-oxidative degradation temperature, typically having a degradation temperature higher than 250° C., more typically higher than 300° C., further typically higher than 350° C., some even higher than 400° C., or higher than 450° C.). Several non-limiting examples are given below:

The thermally, stable polymers within the contemplation of the present disclosure include homopolymers having the repeating structural unit:

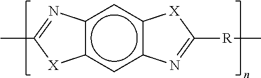

where X is the same or different and is sulfur, oxygen or —NR₁; R is

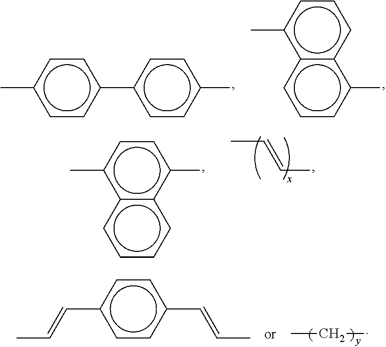

when X is the same or different and is sulfur or oxygen, however, R is nil,

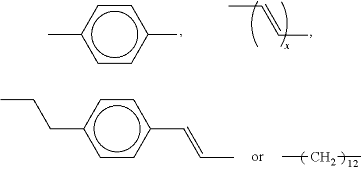

when X is —NR₁; R¹ is hydrogen or hydrocarbyl; x is 1 or 2; v is an integer of 8 to 11; z is 1 or 2; and n is an integer of 2 to 2,000.

Another class of rigid rod and ladder polymers within the contemplation of the present disclosure is characterized by the repeating structural unit

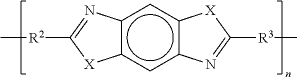

where X, R¹ and n have the meanings given above: R² is

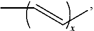

when R³ is

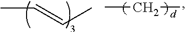

however, R² is

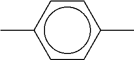

when R³ is

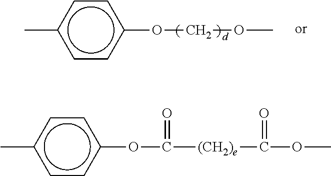

wherein d an integer of 1 to 5; e is an integer of 1 to 18; and f is an integer of 1 to 18.

Yet another class of rigid rod and ladder polymers encompassed by the present disclosure is a polymer having the repeating structural unit

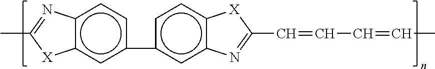

where X and n have the meanings given above.

The present disclosure is not limited to homopolymers of the repeating structural units recited hereinabove. Copolymers of at least two repeating structural units within the scope of one or more of the above generic repeating structural units are within the contemplation of the present disclosure.

Production methods for the aforementioned rigid-rod and ladder polymers are well-known in the art. However, it has not been known that these polymers, in combination with a lithium salt or particles of an inorganic solid electrolyte, can he used as a. polymer composite separator that has desired properties such as a high lithium-ion conductivity and the ability to stop the lithium metal dendrite in a lithium metal battery.

These thermally stable polymers have a high thermo-oxidative degradation temperature, typically having a degradation temperature higher than 250° C., more typically higher than 300° C., further typically higher than 350° C., some even higher than 400° C., or higher than 450° C.). However, these polymers of high thermal stability are not known to have a high lithium-ion conductivity and, hence, not believed to be useful as a separator material in a lithium battery. The incorporation of from 0.1% to 30% by weight of a lithium salt in the thermally stable polymer can significantly increase the lithium-ion conductivity of the polymer composite. The use of particles of an inorganic material (e.g., A1203, SiO2, and various solid electrolyte materials) can also significantly increase the ion conductivity. In addition, we have herein created a third approach of producing pores or through holes in such a thermally stable polymer layer and incorporating a second polymer in these pores or holes. The first polymer imparts thermal stability and flame resistance to the battery cell while the second polymer is more ion-conducting, enabling charge rate capabilities. Furthermore, if the second polymer precursor (polymerizable or curable liquid) is introduced into the pores/holes of the first polymer layer after the battery cell is made, this liquid could permeate into both the anode and the cathode and become the required or desired anolyte and catholyte, respectively. This liquid is then cured or polymerized to become a safe electrolyte.

Alternatively, the second polymer comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof. Any of these polymers may be dissolved in a liquid solvent to form a polymer solution. This polymer solution may be injected into the pores of the first polymer layer (before or after the cell is made), followed by removal of the liquid solvent.

The lithium salt may be selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In certain embodiments, the first polymer and/or the second polymer of the flame-resistant composite separator further comprises a flame retardant additive dispersed therein. Flame-retardant additives are intended to inhibit or stop polymer pyrolysis and combustion processes by interfering with the various mechanisms involved—heating, ignition, and propagation of thermal degradation.

The flame retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

There is no limitation on the type of flame retardant that can be physically or chemically incorporated into the elastic polymer. The main families of flame retardants are based on compounds containing: Halogens (Bromine and Chlorine), Phosphorus, Nitrogen, Intumescent Systems, Minerals (based on aluminum and magnesium), and others (e.g., Borax, Sb₂O₃, and nanocomposites). Antimony trioxide is a good choice, but other forms of antimony such as the pentoxide and sodium antimonate may also be used.

One may use the reactive types (being chemically bonded to or becoming part of the polymer structure) and additive types (simply dispersed in the polymer matrix). Both reactive and additive types of flame retardants can be further separated into several different classes:
1) Minerals: Examples include aluminum hydroxide (ATH), magnesium hydroxide (MDH), huntite and hydromagnesite, various hydrates, red phosphorus and boron compounds (e.g. borates).
2) Organo-halogen compounds: This class includes organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA), and hexabromocyclododecane (HBCD).
3) Organophosphorus compounds: This class includes organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl) dichloroisopentyldiphosphate (V6).
4) Organic compounds such as carboxylic acid and dicarboxylic acid

The mineral flame retardants mainly act as additive flame retardants and do not become chemically attached to the surrounding system (the polymer). Most of the organohalogen and organophosphate compounds also do not react permanently to attach themselves into the polymer. Certain new non halogenated products, with reactive and non-emissive characteristics have been commercially available as well.

In certain embodiments, the flame retardant additive is in a form of encapsulated particles comprising the additive encapsulated by a shell of coating material that is breakable or meltable when exposed to a temperature higher than a threshold temperature (e.g., flame or fire temperature induced by internal shorting). The encapsulating material is a substantially lithium ion-impermeable and liquid electrolyte-impermeable coating material. The encapsulating or micro-droplet formation processes that can be used to produce protected flame-retardant particles are well-known in the art.

In certain embodiments, the second polymer (the polymer in the pores of the first polymer) further comprises a second liquid solvent that permeates into the second polymer of the composite separator wherein the second liquid solvent has a higher flash point or lower vapor pressure as compared to the first liquid solvent (prior to being polymerized into the second polymer inside the pores). Such a second liquid solvent is capable of improving the lithium-ion conductivity and/or flame-retardancy of the composite separator and those of the battery cell.

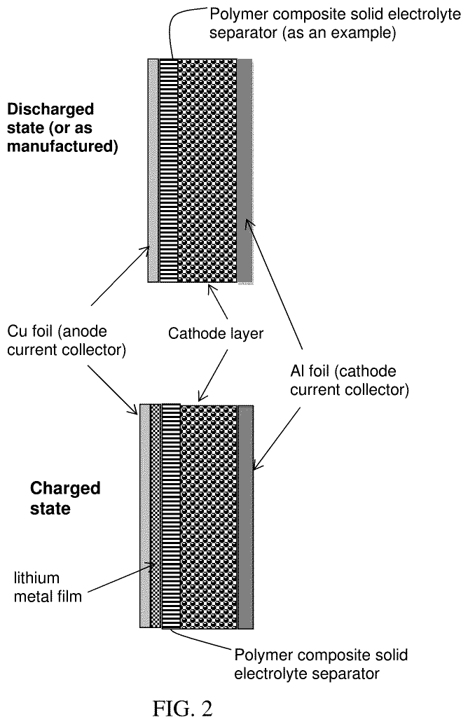

The present disclosure also provides a lithium secondary battery comprising a cathode, an anode, and the presently disclosed flame-resistant composite separator, which is disposed between the cathode and the anode. In certain embodiments, the anode in the lithium secondary battery has an amount of lithium or lithium alloy as an anode active material supported by an anode current collector. In certain other embodiments, as schematically illustrated in FIG. 2, initially the anode has no lithium or lithium alloy as an anode active material supported by an anode current collector when the battery is made and prior to a charge or discharge operation of the battery. This latter configuration is referred to as an anode-less lithium battery. The current collector may be a Cu foil, a layer of Ni foam, a porous layer of nano-filaments, such as graphene sheets, carbon nanofibers, carbon nano-tubes, etc. forming a 3D interconnected network of electron-conducting pathways.

We have discovered that the presently disclosed polymer composite separator provides several unexpected benefits: (a) the formation and penetration of dendrite can be essentially eliminated; (b) uniform deposition of lithium back to the anode side is readily achieved during battery charging; (c) the layer ensures smooth and uninterrupted transport of lithium ions from/to the anode current collector surface (or the lithium film deposited thereon during the battery operations) and through the interface between the current collector (or the lithium film deposited thereon) and the polymer composite separator layer with minimal interfacial resistance; and (d) cycle stability can be significantly improved and cycle life increased. An additional protective layer for the lithium metal anode is not required, but may be used as desired.

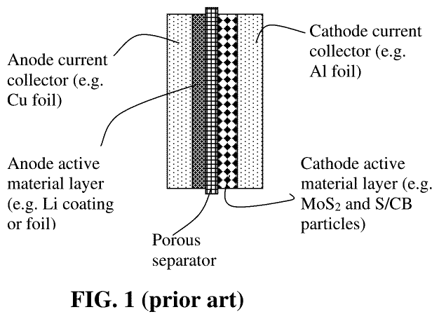

In a conventional lithium metal cell, as illustrated in FIG. 1, the anode active material (lithium) is deposited in a thin film form or a thin foil form directly onto an anode current collector (e.g., a Cu foil) before this anode and a cathode are combined to form a cell. The battery is a lithium metal battery, lithium sulfur battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing a new thermally stable polymer composite separator disposed between the anode (an anode current collector or an anode active material layer) and a cathode active material layer. This composite separator layer has a lithium-ion conductivity no less than 10⁻⁸ S/cm at room temperature (preferably and more typically from 10⁻⁵ S/cm to 10⁻² S/cm).

As schematically shown in FIG. 2, one embodiment of the present disclosure is a lithium metal battery cell containing an anode current collector (e.g., Cu foil), an anode-protecting layer (if so desired; but not shown here), a polymer composite-based separator, and a cathode active material layer. The cathode active material layer is composed of particles of a cathode active material, a conductive additive (not shown) and a resin binder (not shown). A cathode current collector (e.g., Al foil) supporting the cathode active layer is also shown in FIG. 2.

It may be noted that FIG. 2 shows a lithium battery that initially does not contain a lithium foil or lithium coating at the anode (only an anode current collector, such as a Cu foil or a graphene/CNT mat) when the battery is made. The needed lithium to be bounced back and forth between the anode and the cathode is initially stored in the cathode active material (e.g., lithium vanadium oxide LiₓV₂O₅, instead of vanadium oxide, V₂O₅; or lithium polysulfide, instead of sulfur). During the first charging procedure of the lithium battery (e.g., as part of the electrochemical formation process), lithium comes out of the cathode active material, passes through the composite separator and deposits on the anode current collector. The presence of the presently invented composite separator (in good contact with the current collector) enables the uniform deposition of lithium ions on the anode current collector surface. Such a battery configuration avoids the need to have a layer of lithium foil or coating being present during battery fabrication. Bare lithium metal is highly sensitive to air moisture and oxygen and, thus, is more challenging to handle in a real battery manufacturing environment. This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically not air-sensitive. As the charging procedure continues, more lithium ions get to deposit onto the anode current collector, forming a lithium metal film or coating.

Preferably, the inorganic solid electrolyte material for use in a polymer composite is in a fine powder form having a particle size preferably from 10 nm to 30 μm (more preferably from 50 nm to 1 μm). As a first layer, the inorganic solid electrolyte material may be in a fully intered form. The inorganic solid electrolyte material may be selected from an oxide type (e.g., perovskite-type), sulfide type, hydride type, halide type, borate type, phosphate type, lithium phosphorus oxynitride (UPON), Garnet-type, lithium superionic conductor (LISICON), sodium superionic conductor (NASICON), or a combination thereof.

The inorganic solid electrolytes include, but are not limited to, perovskite-type, NASICON-type, garnet-type and sulfide-type materials. A representative and well-known perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in an elastic polymer, does not suffer from this problem.

The sodium superionic conductor (NASKICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a braod series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.6}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include, but are not limited to, the Li₂S—SiS₂ system. The highest reported conductivity in this type of material is 6.9×10⁻⁴ S/cm, which was achieved by doping the Li₂S—P₂S₅ system with Li₃PO₄. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer.

These solid electrolyte particles, if dispersed in a polymer matrix (if having a sufficiently high proportion of these particles; e.g., >60%) can help stop the penetration of lithium dendrites (if present) and enhance the lithium-ion conductivity of certain polymers having an intrinsically low n conductivity.

Typically, a selected polymer for use as the first polymer or the second polymer is originally in a monomer or oligomer state that can be polymerized into a linear or branched polymer or cured to form a cross-linked network polymer or a ladder polymer. A lithium salt and/or particles of an inorganic material may be dissolved or dispersed in the monomer or oligomer solution. In some embodiments, prior to curing, the polymers are dissolved in an organic solvent to form a polymer solution. A lithium salt or an ion-conducting additive (e.g., particles of inorganic solid material) may be added to this solution to form a suspension. This suspension (with the solid particles) can then be formed into a thin layer of polymer composite precursor on a surface of an anode current collector or a solid substrate surface. The polymer composite precursor (e.g., monomer and initiator or oligomer and a crosslinker, etc., along with the solid particles) is then polymerized and/or cured to form a cross-linked polymer. This thin layer of polymer composite may be tentatively deposited on a solid substrate (e.g., surface of a polymer or glass), dried, and separated from the substrate to become a free-standing polymer composite layer. Polymer layer or film formation can be accomplished by using one of several procedures well-known in the art; e.g., spraying, spray-painting, printing, coating, extrusion-based film-forming, casting, etc.

Porous polymer layers may be produced by using one of several procedures well-known in the art; e.g., combined film-forming and foaming procedures (using a physical or chemical blowing agent) and mechanical punching or laser spot ablating of pre-made polymer films.

The pores (e.g., connected pores or through holes) are then impregnated with a reactive solution (e.g., a polymerizable liquid solvent and an initiator and/or crosslinking agent), followed by curing. It may be noted that curing of the liquid solvent may be conducted before or after a battery cell is made.

In the conventional lithium-ion battery or lithium metal battery industry, the liquid solvents listed above as choices of the first liquid solvent are commonly used as a solvent to dissolve a lithium salt therein and the resulting solutions are used as a liquid electrolyte. These liquid solvents typically have a relatively high dielectric constant and are capable of dissolving a high amount of a lithium salt; however, they are typically highly volatile, having a low flash point and being highly flammable. Further, these liquid solvents are generally not known to be polymerizable, with or without the presence of a second liquid solvent.

It is highly advantageous to be able to polymerize the liquid solvent once the liquid electrolyte (having a lithium salt dissolved in the first liquid solvent) is injected into a battery cell or into the porous polymer separator layer. With such an innovative strategy (i.e., in situ polymerization or curing), one can readily reduce the liquid solvent amount or completely eliminate the volatile liquid solvent all together. A desired amount of a second liquid solvent, preferably a flame-resistant liquid solvent, may be retained in the battery cell or in the pores of the separator to improve the lithium-ion conductivity of the electrolyte or the separator. Desirable flame retardant-type second liquid solvents are, as examples, alkyl phosphates, alkyl phosphonates, phosphazenes, hydrofluoroethers, fluorinated ethers, and fluorinated esters.

This strategy enables us to achieve several desirable features of the resultant separator, electrolyte and battery:
a) no liquid electrolyte leakage issue (the in situ cured polymer being capable of holding the remaining liquid together, if present, to form a gel);
b) adequate lithium salt amount can be dissolved in the electrolyte and the separator, enabling a good lithium ion conductivity;
c) reduced or eliminated flammability (only a solid polymer and, optionally, a non-flammable second liquid are retained in the pores);
d) good ability of the electrolyte to wet the anode/cathode active material surfaces (hence, significantly reduced interfacial impedance and internal resistance);
e) processing ease and compatibility with current lithium-ion battery production processes and equipment, etc.; and
f) enabling a high cathode active material proportion in the cathode electrode (typically 75-97%, in contrast to typically less than 75% by weight of the cathode active material when working with a conventional solid polymer electrolyte or inorganic solid electrolyte. This disclosed in situ-cured polymer electrolyte approach is of significant utility value since most of the organic solvents in the lithium-ion cell electrolytes are known to be volatile and flammable, posing a fire and explosion danger. Further, current inorganic solid-state electrolytes are not compatible with existing lithium-ion battery manufacturing equipment and processes.

In certain preferred embodiments, the second liquid solvent comprises a flame-resisting or flame-retardant liquid selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

Thus, the first and/or the second liquid solvent may be selected from the group consisting of fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

The first liquid solvent and/or second liquid solvent may be selected from a phosphate, phosphonate, phosphinate, phosphine, or phosphine oxide having the structure of:

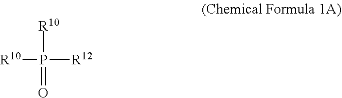

wherein R¹⁰, R¹¹, and R¹², are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, and the second liquid solvent is stable under an applied electrical potential no less than 4 V.

In some embodiments, the first and/or the second liquid solvent comprises a. phosphoranimine having the structure of:

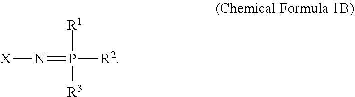

wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and Ware represented by at least two different substituents and wherein X is selected from the group consisting of an organosilyl group or a tert-butyl group. The R¹, R², and R³ may be each independently selected from the group consisting of an alkoxy group, and an aryloxy group.

The cathode may contain a cathode active material (along with an optional conductive additive and an optional resin binder) and an optional cathode current collector (such as Al foil) supporting the cathode active material. The anode may have an anode current collector, with or without an anode active material in the beginning when the cell is made. It may be noted that if no conventional anode active material, such as graphite, Si, SiO, Sn, and conversion-type anode materials, and no lithium metal is present in the cell when the cell is made and before the cell begins to charge and discharge, the battery cell is commonly referred to as an “anode-less” lithium cell.

It may be noted that these first liquid solvents herein disclosed, upon polymerization, become essentially non-flammable. These liquid solvents were typically known to be useful for dissolving a lithium salt and not known for their polymerizability or their potential as an electrolyte polymer.

In some preferred embodiments, the battery cell contains substantially no volatile liquid solvent therein after polymerization. However, it is essential to initially include a liquid solvent in the cell, enabling the lithium salt to get dissociated into lithium ions and anions. A majority (>50%, preferably >70%) or substantially all of the unpolymerized first liquid solvent (particularly the organic solvent) is then removed just before or after curing of the reactive additive. With substantially 0% liquid solvent, the resulting electrolyte is a solid-state electrolyte.

With less than 30% liquid solvent, we have a quasi-solid electrolyte. Both are highly flame-resistant.

In certain embodiments, the electrolyte exhibits a vapor pressure less than 0.001 kPa when measured at 20° C., a vapor pressure less than 60% of the vapor pressure of the combined first liquid solvent and lithium salt alone prior to polymerization, a flash point at least 100 degrees Celsius higher than a flash point of the liquid solvent prior to polymerization, a flash point higher than 200° C., or no measurable flash point and wherein the polymer has a lithium ion conductivity from 10⁻⁸ S/cm to 10⁻² S/cm at room temperature.

A lower proportion of the unpolymerized liquid solvent in the electrolyte leads to a significantly reduced vapor pressure and increased flash point or completely eliminated flash point (un-detectable). Although typically by reducing the liquid solvent proportion one tends to observe a reduced lithium-ion conductivity for the resulting electrolyte; however, quite surprisingly, after a threshold liquid solvent fraction, this trend is diminished or reversed (the lithium-ion conductivity can actually increase with reduced liquid solvent in some cases).

The presence of a second liquid solvent is designed to impart certain desired properties to the polymerized electrolyte, such as lithium-ion conductivity, flame retardancy, ability of the electrolyte to permeate into the electrode (anode and/or cathode) to properly wet the surfaces of the anode active material and/or the cathode active material.

In some embodiments, the first and/or the second liquid solvent is selected from a fluorinated carbonate, hydrofluoroether, fluorinated ester, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), or a combination thereof.

Desirable polymerizable liquid solvents can include fluorinated monomers having unsaturation (double bonds or triple bonds) in the backbone or cyclic structure (e.g., fluorinated vinyl carbonates, fluorinated vinyl monomers, fluorinated esters, fluorinated vinyl esters, and fluorinated vinyl ethers). These chemical species may also be used as a second liquid solvent in the presently disclosed electrolyte. Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

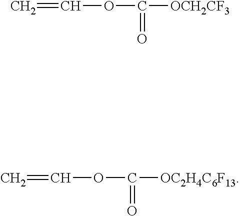

These liquid solvents, as a monomer, can be cured in the presence of an initiator (e.g., 2-Hydroxy-2-methyl-l-phenyl-propan-l-one, Ciba DAROCUR-1173, which can be activated by UV or electron beam):

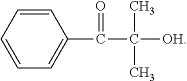

In some embodiments, the fluorinated carbonate is selected from vinyl- or double bond-containing variants of fluoroethylene carbonate (FEC), DFDMEC, FNPEC, hydrofluoro ether (FIFE), trifluoro propylene carbonate (FPC), or methyl nonafluorobutyl ether (MFE), wherein the chemical formulae for FEC, DFDMEC, and FNPEC, respectively are shown below:

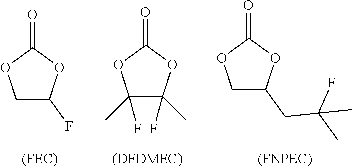

Desirable sulfones as a polymerizable first liquid solvent or as a second liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone.

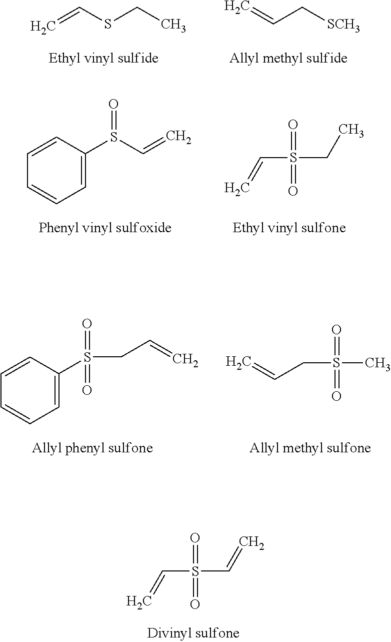

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R=NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

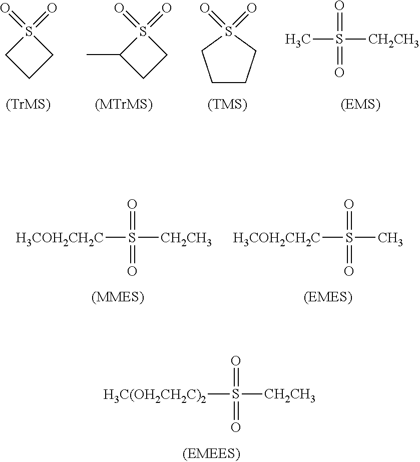

The cyclic structure, such as TrMS, MTrMS, and TMS, can be polymerized via ring-opening polymerization with the assistance of an ionic type initiator.

The nitrile may be selected from AND, GLN, SEN, succinonitrile, or a combination thereof and their chemical formulae are given below:

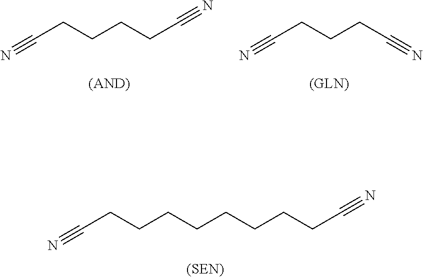 [SMILES: N#CCCCCC#N ; N#CCCCC#N ; N#CCCCCCCCCC#N]

In some embodiments, the phosphate (including various derivatives of phosphoric acid) alkyl phosphonate, phosphazene, phosphite. or sulfate is selected from tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

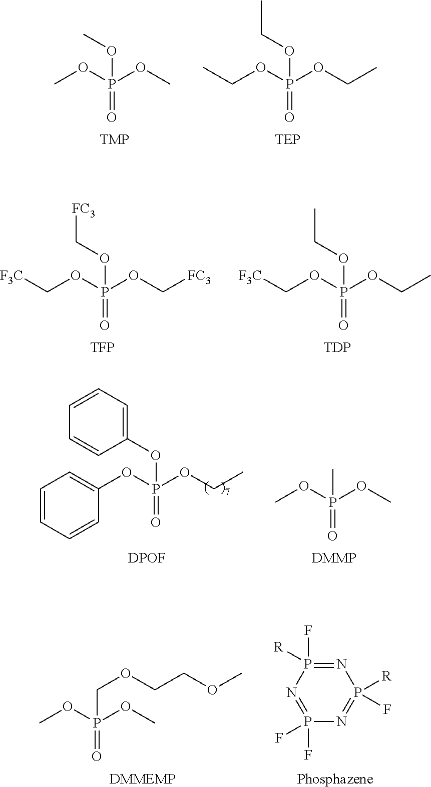

wherein R=H, NH₂, or C₁-C₆ alkyl.

Phosphonate moieties can be readily introduced into vinyl monomers to produce allyl-type, vinyl-type, styrenic-type and (meth)acrylic-type monomers bearing phosphonate groups (e.g., either mono or bisphosphonate). These liquid solvents may serve as a first or a second liquid solvent in the electrolyte composition. The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

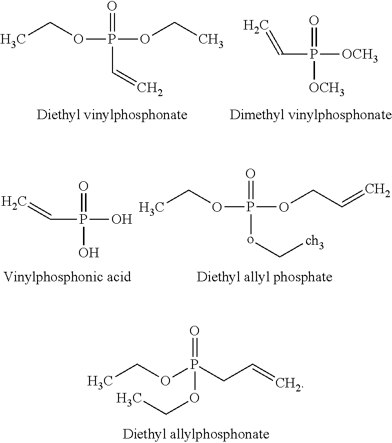

Examples of initiator compounds that can be used in the polymerization of vinylphosphonic acid are peroxides such as benzoyl peroxide, toluy peroxide, di-tert.butyl peroxide, chloro benzoyl peroxide, or hydroperoxides such as methylethyl ketone peroxide, tert.

butyl hydroperoxide, cumene hydroperoxide, hydrogen Superoxide, or azo-bis-iso-butyro nitrile, or sulfinic acids such as p-methoxyphenyl-sulfinic acid, isoamyl-sulfinic acid, benzene-sulfinic acid, or combinations of various of such catalysts with one another and/or combinations for example, with formaldehyde sodium sulfoxylate or with alkali metal sulfites.

The siloxane or silane may be selected from alkylsiloxane (Si-O), alkyylsilane (Si-C), liquid oligomeric silaxane (—Si—O—Si—), or a combination thereof.

The reactive solution or suspension may further comprise an amide group selected from N,N-dimethylacetamide, N,N-diethylacetarnide, N,N-dimethylformamide, N,N-diethylformamide, or a combination thereof.

The crosslinking agent may comprise a compound having at least one reactive group selected from a hydroxyl group, an amino group, an imino group, an amide group, an acrylic amide group, an amine group, an acrylic group, an acrylic ester group, or a mercapto group in the molecule. In certain embodiments, the crosslinking agent is selected from poly(diethanol) diacrylate, poly(ethyleneglycol)dimethacrylate, poly(diethanol) dimethylacrylate, polyethylene glycol) diacrylate lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

The crosslinking agent may comprise a compound having at least one reactive group selected from a hydroxyl group, an amino group, an imino group, an amide group, an amine group, an acrylic group, or a mercapto group in the molecule. The amine group is preferably selected from Chemical Formula 2:

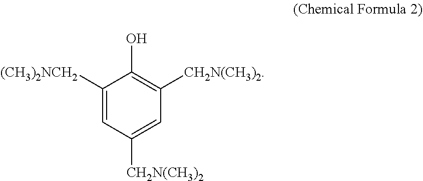

In the rechargeable lithium battery, the reactive solution or suspension (to be cured into a polymer) may further comprise a chemical species represented by Chemical Formula 3 or a derivative thereof and the crosslinking agent comprises a chemical species represented by

Chemical Formula 4 or a derivative thereof:

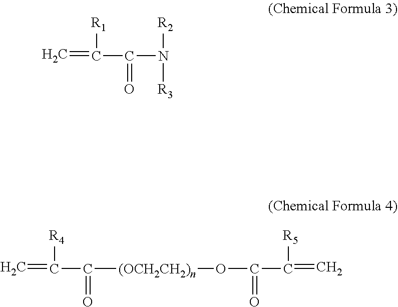

where R₁ is hydrogen or methyl group, and R₂ and R₃ are each independently one selected from the group consisting of hydrogen, methyl, ethyl, propyl, dialkylaminopropyl (—C₃ H₆ N(R′)₂) and hydroxyethyl (CH₂ CH₂ OH) groups, and R₄ and R₅ are each independently hydrogen or methyl group, and n is an integer from 3 to 30, wherein R′ is C₁-C₅ alkyl group.

Examples of suitable vinyl monomers having Chemical formula 3 include acrylamide, N,N-dimethylacrylamide, N,N-diethylacrylamide, N-isopropylacrylamide, N,N-dimethylamino-propylacrylamide, and N-acryloylmorpholine. Among these species, N-isopropylacrylamide and N-acryloylmorpholine are preferred.

The crosslinking agent is preferably selected from N,N-methylene bisacrylamide, epichlorohydrin, 1,4-butanediol diglycidyi ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobomyl methacrylate, poly (acrylic acid) (PAA), methyl methacrylate, isobomyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

Preferably, the lithium salt occupies 0.1%-30% by weight and the crosslinking agent and/or initiator occupies 0.1-50% by weight of the reactive polymer precursor.

The polymer may contain a simultaneous interpenetrating network (SIN) polymer, wherein two cross-linking chains intertwine with each other, or a semi-interpenetrating network polymer (semi-IPN), which contains a cross-linked polymer and a linear polymer.

The presently invented lithium secondary batteries can contain a wide variety of cathode active materials. The cathode active material layer may contain a cathode active material selected from an inorganic material, an organic material, a polymeric material, or a combination thereof.

The inorganic material may be selected from a metal oxide, metal phosphate, metal silicide, metal selenide, transition metal sulfide, sulfur, lithium polysulfide, selenium, lithium selenide, or a combination thereof.

The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤1.

Examples of the lithium transition metal oxide- or lithium mixed transition metal oxide-based positive active materials include: Li (M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(CoₓM_{1-X})O₂, where M is a metal, (e.g. Li(Co_{X}Ni_{1-X})O₂ and Li(Co_{X}Fe_{1-X})O₂, ), Li_{1-W}(Mn_{X}Ni_{Y}CO_{z})O₂, (e.g. Li(Co_{X}Mn_{Y}Ni_{(1-X-Y)})O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂), Li_{1-W}(Mn_{X}Ni_{X}Co_{1-2X})O₂, Li_{1-W}Mn_{X}Ni_{Y}CoAl_{W})O₂, Li_{1-W} (Ni_{X}Co_{Y}Al_{Z})O₂, where W=0-1, (e.g., Li(Ni_{0.8}Co_{0.15}Al_{0.05})O₂), Li_{1-W}(Ni_{X}Co_{Y}M_{Z})O₂, where M is a metal, Li_{1-W}(Ni_{X}Mn_{Y}M_{Z}O₂, where M is a metal, Li(Ni_{X}Mn_{Y}Cr_{2-X})O₄, LiM′M″₂O₄, where M′ and M″ are different metals (e.g., LiMn_{2-Y-Z}NiyO₄, LiMn_{2-Y-Z}Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-z}F_{z}, Li₂MnO₃) Li_{X}V_{Y}O_{Z}, e.g. LiV₃O₈, LiV₂O₅, and LiV₆O₁₃. This list includes the well-known lithium nickel cobalt manganese oxides (NCM) and lithium nickel cobalt manganese aluminum oxides (NCM), among others.

The metal oxide contains a vanadium oxide selected from the group consisting of VO₂, LiₓVO₂, V₂O₅, LiₓV₂O₅, V₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic cathode active material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%. In some preferred embodiments, prelithiated anode comprises Si that is prelithiated to approximately 60-100% and the cathode comprises a cathode active material that is initially lithium-free.

The inorganic cathode active material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

There is no limitation on the type of organic materials or polymeric materials that can used in presently disclosed battery.

The working electrolyte used in the lithium battery may be a liquid electrolyte, polymer gel electrolyte, solid-state electrolyte (including solid polymer electrolyte, inorganic electrolyte, and composite electrolyte), quasi-solid electrolyte, ionic liquid electrolyte. The liquid electrolyte or polymer gel electrolyte typically comprises a lithium salt dissolved in an organic solvent or ionic liquid solvent. There is no particular restriction on the types of lithium salt or solvent that can be used in practicing the present disclosures.

There are a wide variety of processes that can be used to produce layers of polymer composite separators. These include coating, casting, painting, spraying (e.g., ultrasonic spraying), spray coating, printing (screen printing, 3D printing, etc.), tape casting, extrusion, etc. The creation of pores or holes in a polymer or polymer composite layer may be accomplished by the use of a foaming agent (blowing agent) in the polymer matrix during the process of polymer or polymer composite layer formation. The through-holes in a polymer or polymer composite layers may be produced by a focused laser beam or mechanical punching. These processes are well-known in the art.

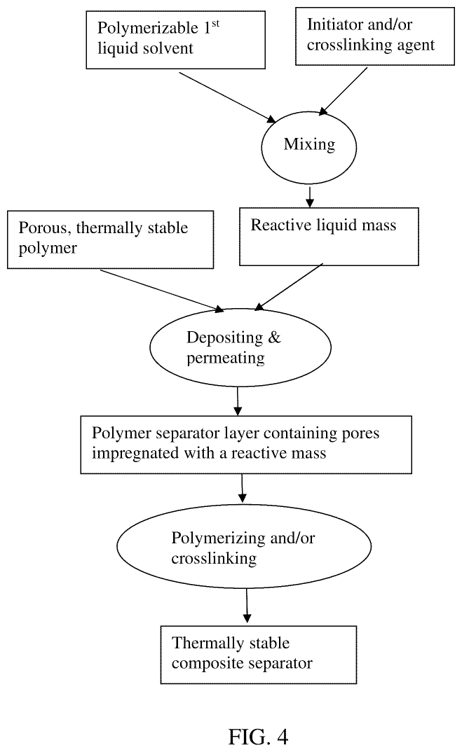

The disclosure also provides a process for manufacturing the polymer composite separator described above. As illustrated in FIG. 4, the process may comprise: (a) providing a porous layer of the first polymer having pores (preferably comprising connected pores or through holes, which are pores that run through a thickness) of the porous layer; (b) impregnating the pores or holes with a reactive mass or a polymer solution wherein the reactive mass comprises a monomer (e.g., the first liquid solvent that is polymerizable) and an initiator or an oligomer and a curing agent, or wherein the polymer solution comprises the second polymer dissolved in a liquid solvent; and (c) forming the second polymer by in situ polymerizing and/or curing the reactive mass in the pores or by removing the solvent from the polymer solution to solidify or precipitate our the second polymer inside the pores of the first polymer layer.

Preferably, the reactive mass comprises a first solvent that is polymerizable or crosslinkable inside pores of the first polymer layer. The first solvent may be selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3,5-trioxane (TXE), 1,3- acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, tetrahydrofuran, phosphates, phosphonates, phosphina.tes, phosphines, phosphine oxides, phosphonic acids, phosphorous acid, phosphites, phosphoric acids, phosphazene compounds, ionic liquids, derivatives thereof, and mixtures thereof.

Step (a) and step (b) may be conducted inside a battery cell after the porous layer of the first polymer is combined with an anode and a cathode to form the cell.

The process further comprises a step (d) of impregnating a second liquid solvent, containing a lithium salt dispersed or dissolved therein, into the pores or holes of the porous first polymer layer.

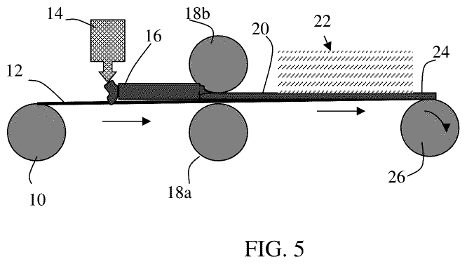

Preferably, as schematically illustrated in FIG. 5, the process comprises a roll-to-roll procedure wherein step (a) and (b) comprise (i) continuously feeding a layer of the porous first polymer layer 12 from a feeder roller 10 to a dispensing zone where the reactive mass (or the polymer solution) 16 is dispensed and deposited onto the porous first polymer layer 12, allowing the reactive mass or the polymer solution to permeate into the pores. The impregnated polymer layer is driven toward a pair of rollers (18a, 18b). Step (c) comprises (ii) moving the reactive mass-or polymer solution-impregnated porous polymer layer 20 into a reacting zone or solidification zone 22, which is provided with a curing means (heat, UV, electron beam, high energy radiation, etc.). The reactive mass or polymer solution is exposed to heat, ultraviolet light, or high-energy radiation to initiate the polymerization or curing procedure, or wherein the solvent in the polymer solution is removed, to form a continuous layer 24 of polymer composite comprising both the first polymer and the second polymer (or partially or fully cured polymer). The process further comprises (iii) collecting said polymer composite on a winding roller, 26. One may unwind the roll at a later stage.

It may be noted again that the procedure of curing (polymerizing and/or crosslinking) the first solvent may be conducted before or after the separator is combined with an anode and a cathode to form a battery cell.

In certain preferred embodiments, the porous first polymer layer coming out of a winding roller, may be supported on a solid substrate, which may be an anode current collector, an anode active material layer, or a cathode active material layer. In other words, this polymer composite separator can be directly deposited onto a layer of anode active material, an anode current collector, or a layer of cathode active material. This is achievable because curing of the polymer does not require a high temperature; curing temperature being typically lower than 300° C. or even lower than 100° C.

This procedure of exposing the reactive mass to an energy source (heat, UV, electron beam, Gramma radiation, etc.) to get the curing reactions initiated is helpful if this composite layer will be soon incorporated into a battery cell. This early start would reduce the required time to complete the polymerization and/or crosslinking reactions. If this reactive composite layer is to be stored for some time, this energy exposure procedure may be preferably conducted after the battery cell is made to activate and complete the in situ curing procedure.

The process may further comprise cutting and trimming the layer of polymer composite into one or multiple pieces of polymer composite separators.

The process may further comprise a step of combining an anode, the polymer composite separator, an electrolyte, and a cathode electrode to form a lithium battery.

The lithium battery may be a lithium metal battery, lithium-ion battery, lithium-sulfur battery, lithium-selenium battery, lithium-air battery, etc. The cathode active material in the lithium-sulfur battery may comprise sulfur or lithium polysulfide.

### EXAMPLE 1: PREPARATION OF SOLID ELECTROLYTE POWDER, LITHIUM NITRIDE PHOSPHATE COMPOUND (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. Some amount of the powder particles was dispersed in a polymer to form a polymer composite.

### EXAMPLE 2: PREPARATION OF SOLID ELECTROLYTE POWDER, LITHIUM SUPERIONIC CONDUCTORS WITH THE Li₁₀GeP₂S₁₂ (LGPS)-type structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting solid electrolyte material was then subjected to grinding in a mortar to form a powder sample to be later added as inorganic solid electrolyte particles dispersed in an intended polymer matrix of a composite separator (examples of binder/matrix polymers are given below). Some amount of the powder particles was dispersed in a polymer to form a polymer composite.

### EXAMPLE 3: PREPARATION OF GARNET-TYPE SOLID ELECTROLYTE POWDER

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736). For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was dispersed in several polymers discussed in the examples below.

### EXAMPLE 4: PREPARATION OF SODIUM SUPERIONIC CONDUCTOR (NASICON) TTYPE SOLID ELECTROLYTE POWDER

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed consists of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C. Some amount of the powder particles was dispersed in a polymer to form a polymer composite. For instance, the NASICON powder was dispersed in cyanoethyl poly(vinyl alcohol), which was in situ cured using LiPF₆ as a crosslinking agent in succinonitrile to form a polymer composite layer.

### EXAMPLE 5: PREPARATION OF HEAT/FLAME-RESISTANT POLYBENZOXAZOLE (PBO) COMPOSITE LAYERS FOR USE IN POLYMER COMPOSITE SEPARATORS

Polybenzoxazole (PBO) films were prepared via casting and thermal conversion from its precursor, methoxy-containing polyaramide (MeO-PA). As examples, monomers of 4, 4′-diamino-3,3′-dimethoxydiphenyl (DMOBPA), and isophthaloyl dichloride (IPC) were selected to synthesize PBO precursors, methoxy-containing polyaramide (MeO-PA) solution. This MeO-PA solution for casting was prepared by polycondensation of DMOBPA and IPC in DMAc solution in the presence of pyridine and LiCl at −5° C. for 2 hr, yielding a 20 wt % pale yellow transparent MeO-PA solution. The inherent viscosity of the resultant MeO-PA solution was 1.20 dL/g measured at a concentration of 0.50 g/dl at 25° C. This MeO-PA solution was added with powder of LLZO prepared in Example 3 and diluted to a concentration of 15 wt % of solid in DMAc for casting.

The as-synthesized MeO-PA/LLZO was cast onto a glass surface to form thin films (25-50 μm) under a shearing condition. The cast film was dried in a vacuum oven at 100° C. for 4 hr to remove the residual solvent. Then, the resulting film with a thickness of approximately 22-35 μm was treated at 200° C-350° C. under N₂ atmosphere in three steps and annealed for about 2 hr at each step. This heat treatment serves to thermally convert MeO-PA into PBO to obtain composite layers. The chemical reactions involved may be illustrated below:

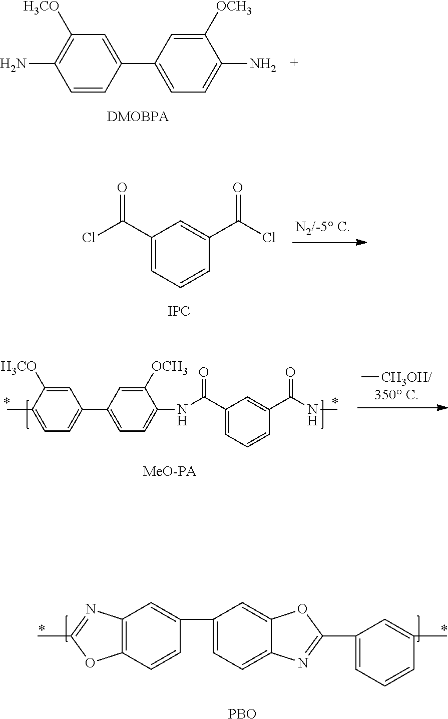

For the preparation of 3 samples, just before casting of the 3 polymer precursor solutions, a desired amount of selected flame retardant (e.g. aluminum hydroxide and a phosphorus compound, formula given below, from Amfine Chemical Corp.), were added:

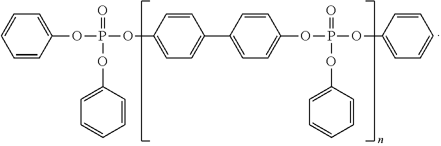

Through holes (30-65% area fractions or volume fractions) were produced my mechanically punching the polymer composite layers. In certain samples, the holes were filled with a poly(vinylidene fluoride)-hexafluoropropylene (PVDF-HFP)/THF solution, followed by removing the THF, allowing PVDF-HFP to precipitate out inside the holes. The PVDF-HFP polymer contains 10% by weight of a lithium salt (lithium hexafluorophosphate, LiPF₆). This type of polymer composite separator can be combined with an anode and a cathode to make a cell.

Alternatively, in other samples, the lithium-ion cells prepared comprise an anode of graphene-protected Si particles, a cathode of NCM-622 particles, and a porous composite separator comprising unfilled through holes. The cells were then filled with liquid vinyl sulfone (VS). Vinyl sulfone can be polymerized with several anionic-type initiators; e.g., n-BuLi, ZnEt₂, LiN(CH₂)₂, and NaNH₂. The second (optional) liquid solvent may be selected from pyridine, sulfolane, Trimethyl phosphate (TMP), Trifluoro-Phosphate (TFP), etc. Trimethyl phosphate has the following chemical structure:

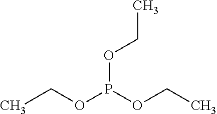

As an example, a mixture of VS, TFP, n-BuLi (1.0% relative to PVS), and LiBF₄ (0.5 M) was thoroughly mixed and injected into the battery cell, permeating into pores/holes of the polymer separator layer, anode active layer, and cathode active layer. The cell was maintained at 30° C. overnight to cure the polymer.

### EXAMPLE 6: PREPARATION OF POROUS POLYIMIDE (PI)-CERAMIC COMPOSITE LAYERS)

The synthesis of polyimide (PI) involved poly(amic acid) (PAA, Sigma Aldrich) formed from pyromellitic dianhydride (PMDA) and oxydianiline (ODA). Prior to use, both chemicals were dried in a vacuum oven at room temperature. Next, 4 g of the monomer ODA was dissolved into 21 g of DMF solution (99.8 wt %). This solution was stirred at 5° C. for 4 hours using a magnetic stir bar. Subsequently, the viscous polymer solution was cast onto a glass substrate and heat treated to create an opaque, black layer having a thickness of about 16 μm. Representative chemical reactions involved in the formation of polyimide polymers from precursors (monomers or oligomers) are given below:

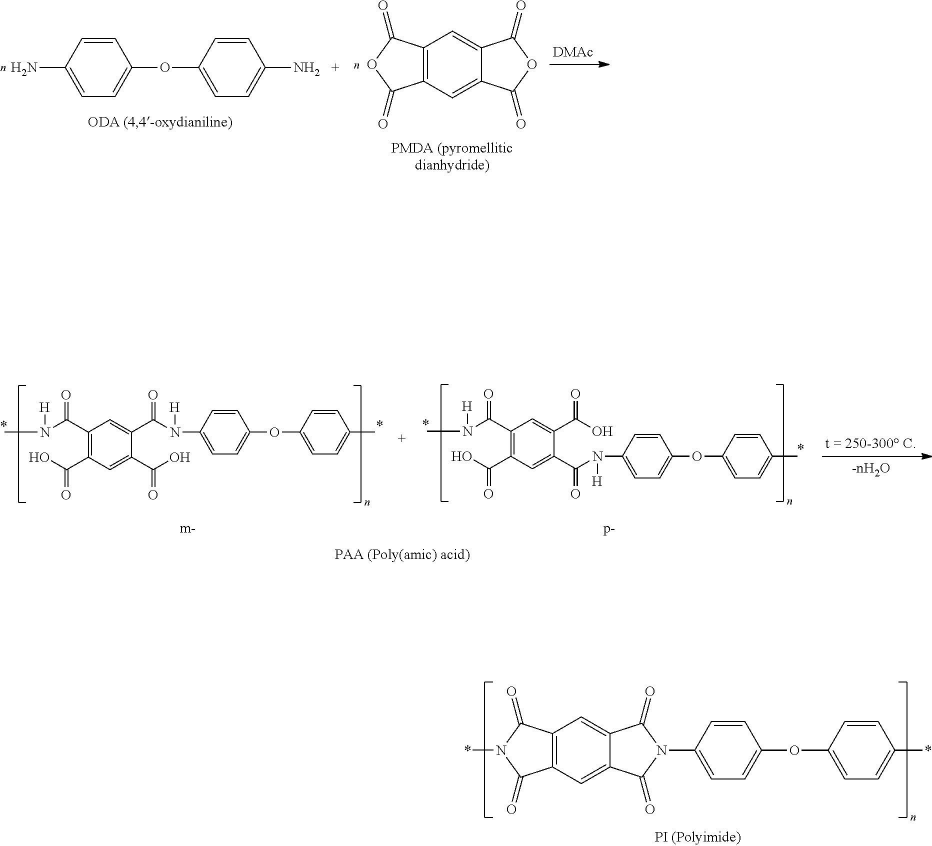

For the preparation of some porous samples, a small amount of a foaming agent was mixed into the PAA solution before PAA was converted to polyimide. This resulted in the formation of porous PI layers. These porous PI layers were impregnated with a polymerizable liquid solvent having a lithium salt dissolved therein, before or after the cells were assembled.

In one example, vinylene carbonate (VC) as a first liquid solvent, TEP as a second liquid solvent (flame retardant), and poly(ethylene glycol) diacrylate (PEGDA, as a crosslinking agent) were stirred under the protection of argon gas until a homogeneous solution was obtained. The TEP has the following chemical structure:

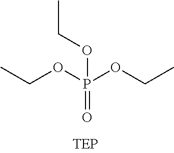

Subsequently, lithium hexafluoro phosphate, as a lithium salt, was added and dissolved in the above solution to obtain a reactive mixture solution, wherein the weinlit fractions of VC, TEP. polyethylene glycol diacrylate, and lithium hexafluoro phosphate were 80 wt %, 5 wt %. 10 wt %, and 5 wt %, respectively.

A lithium metal cell was made, comprising a lithium metal foil as the anode active material, a cathode comprising LiCoO₂, and a porous PI separator. This cell was then injected with the reactive solution mixture (10% by weight based on the total cell weight). The cell was then irradiated with electron beam at room temperature until a total dosage of 40 Gy was reached. In-situ polymerization of the polymerizable first liquid solvent in the battery cell was accomplished, resulting in a quasi-solid electrolyte that permeates into the cathode to wet the surfaces of LiCoO₂, particles, impregnates the porous PI separator layer, and comes in contact with the lithium metal in the anode.

### EXAMPLE 7: POLYIMIDE BASED POLYMER COMPOSITE SEPARATORS

The chemicals used in this project include methanol, tetrahydrofuran (THF), 3,3′,4,4′-Benzophenonetetracarboxylic dianhydride (BTDA), 5-norbornene-2,3-dicarboxylic anhydride (NA), 4,4′-Methylene dianiline (MDA), and 4,4′-Methylenebis-(5-isopropyl-2-methylaniline) (CDA). A representative synthesis procedure for a PMR resin from 4,4′-methylenebis-(5-isopropyl-2-methylaniline), as a first step to produce PI, is briefly described below: In a dry, N₂-filled glove box, BTDA (0.7825 g, 2.43 mmol) and NA (0.3995 g, 2.44 mmol) were added to a 25 mL round-bottomed flask. The flask was removed from the glove box and MeOH (8.5 mL) was added. The mixture was stirred and refluxed for 2 h, during which time the anhydride powders dissolved and the solution turned pale yellow. The solution was then left to cool to ambient temperature. Subsequently, CDA (1.1659 g, 3.76 mmol) was added to the solution. The bisaniline got rapidly dissolved and the solution transitioned to a darker yellow/amber color. The solution was left to stir overnight and the solvent was then evaporated to yield 2.24 g of a bright yellow amic acid powder. In a procedure, a desired amount (10% by weight based on the final PI weight) of a lithium salt (bis-trifluoromethyl sulfonylimide lithium, LiN(CF₃SO₂)₂) and 1.8 g of the powder was heated in an oven at 200° C. for 2 h in air followed by 30 min at 230° C. for imidization.

The second step entailed cross-linking of the PMR resin, which was carried out according to the following procedure: A 0.5-inch diameter cylindrical compression mold was charged with 0.3502 g of imide powder. A piston was inserted into the cylinder and the mold was placed into a 1-ton heated press to cure. With a minimal pressure applied (just enough to contact the mold assembly to allow for heating from the top and bottom), the temperature was ramped from ambient temperature to 280° C. at 5.5 ° C. min⁻¹. A pressure of 184 psi was applied while the temperature was further ramped to 315° C. at 0.5° C. min⁻¹. The temperature and pressure were held for 90 min and then the mold was allowed to cool to ambient temperature. A solid, dark brown-colored disc was recovered.

The disc with a thickness of 22 μm was punched to generate through holes (approximately 61% volume fraction) and used as a separator in a lithium cell. The porous disc was impregnated with poly(vinylidene fluoride)-hexafluoropropylene (PVDF-HFP) via dip coating with a polymer solution of PVDF-HFP in acetone.

### EXAMPLE 8: COMPOSITE SEPARATOR LAYER BASED ON PHENOLIC RESIN

Phenol formaldehyde resins (PF) are synthetic polymers obtained by the reaction of phenol or substituted phenol with formaldehyde. A desired amount of a flame retardant (e.g. decabromodiphenyl ethane (DBDPE), brominated poly(2,6-dimethyl-1,4-phenylene oxide) (BPPO), and melamine-based flame retardant, separately) was added into the reactive mass solution. The retardant-containing PF resin, alone or with up to 90% by weight inorganic material particles (fine particles of NASICON-type solid electrolyte), was made into 20-pm thick film and cured under identical curing conditions: a steady isothermal cure temperature at 100° C. for 2 hours and then increased from 100 to 170° C. and maintained at 170° C. to complete the curing reaction, The resultant PF resin composite layers were mechanically punched to contain through holes. In an alternative approach, approximately 55% by volume of NaCl (as a sacrificial material) was dispersed in the PF-based reactive mass. Upon completion of the curing reaction, NaCl was removed by soaking the sample in water to generate connected pores.

These porous separators were then each combined with an anode and a cathode to form a battery cell. Two types of battery cells were studied in this example: a lithium/NCM-811 cell (initially the cell being lithium-free at the anode side) and a lithium/NCA cathode cell (initially lithium-free at the anode). Each cell was injected with a reactive liquid mass containing vinyl carbonate (VC) as the polymerizable liquid solvent, azodiisobutyronitrile (AIBN) as the initiator, and lithium difluoro(oxalate) borate (LiDFOB) as the lithium salt. Solutions containing 1.5 M LiDFOB in VC and 0.2 wt % AIBN (vs VC) were prepared. The electrolyte solutions were separately injected into different dry battery cells, allowing the electrolyte solution to permeate into the anode, into the cathode (wetting out the cathode active material; e.g., NCA particles), and into the porous separator layer. The battery cells were stored at 60° C. for 24 h and then 80° C. for another 2 h to obtain polymerized VC. The polymerization scheme of VC is shown below:

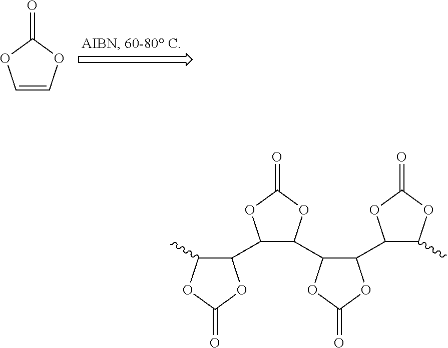

### EXAMPLE 9: PREPARATION OF POROUS POLYBENZIMIDAZOLE (PBI) COMPOSITE SEPARATORS

PBI was prepared by step-growth polymerization from 3,3′,4,4′-tetraaminobiphenyl and diphenyl isophthalate (an ester of isophthalic acid and phenol). The PBI used in the present study was obtained from PBI Performance Products in a PBI solution form, which contains 0.7 dl/g PBI polymer dissolved in dimethylacetamide (DMAc). A lithium salt (e.g., 10% lithium borofluoride (LiBF₄) or lithium trifluoro-metasulfonate (LiCF₃SO₃)) was then dissolved/dispersed in the DMAc solution. On a separate basis, particles of inorganic solid electrolyte (LGPS-type solid electrolyte) were added into the DMAc solution. The lithium salt-PBI and inorganic-PBI composite films were cast onto the surface of a glass substrate and cured.

The PBI composite films with through holes were then filled with a polymerizable first liquid solvent after a battery cell was made. Under the protection of an argon gas atmosphere, vinyl ethylene sulfite (VES), hydrofluoro ether (HFE), and tetm(ethylene glycol) diacrylates were stirred evenly to form a solution, Bis trifluoromethyl sulfimide lithium was then dissolved in the solution to obtain a solution mixture, in this solution mixture, the weight fractions for the four ingredients were VEC (40%). FIFE (20%), tetra(ethylene glycol) dia.crylates (20%), and his trifluoromethyl sulfimide (10%). The cell was exposed to electron beam at 50° C. until a dosage of 20 kGy was reached. VEC was polymerized and crosslinked to become a solid polymer, but HFE remained as a liquid.

Three types of battery cells were studied in this example: a lithium/NCM-811 cell (initially the cell being lithium-free), a Si/NCM-811 Li-ion cell, and a lithium-sulfur cell. Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the cells containing a polymer composite separator layer having a second polymer residing in its pores perform very well in terms of cycling stability and the energy storage capacity and yet these cells are flame resistant and relatively safe.

### EXAMPLE 10: POROUS LADDER POLYMER-SOLID ELECTROLYTE COMPOSITE SEPARATORS

As an example of a ladder polymer, a Si-containing ladder polymer was synthesized. This began with the synthesis of a prepolymer, To a 300 nil volume three necked flask substituted with nitrogen, were charged 50 g of methyl vinyl bis-(dimethylamino)silane and 80 ml of n-hexane. Then, 11 mmol of n-butyl lithium in an n-hexane solution were added to carry out polymerization under stirring. After carrying out the polymerizing reaction at a temperature of 40° C. for 3 hours, the reaction solution was dropped in methanol to precipitate the polymer. The polymer was washed and filtered repeatedly for 3-4 times using methanol and then dried under vacuum. The polymer was obtained in an amount of 23.3 g.

In a 500 ml volume three necked flask substituted with nitrogen. 20 g of the prepolymei obtained in the step above were charged and dissolved in 300 ml of toluene. After dissolving, 30 ml of glacial acetic acid were added dropwise to react under a nitrogen stream while stirring a.t room temperature. After one hour reaction, 1.5 g of dimethyl diacetoxysilane were added and the stirring was continued for 15 min and then 2.5 ml of water were added dropwise to react for 10 min and the reaction was continued for one hour while stirring at room temperature. After the reaction was completed, the resultant solution was transferred to a separating funnel and 200 ml of diethyl ether were added. Then, water was added for washing through shaking to separate the aqueous layer. After repeating the water washing procedure for three times, the organic layer was separated, incorporated with anhydrous potassium carbonate and dried over night. After filtering Out potassium carbonate, the solution was transferred to a flask and heated in a warm water bath to distill off the ether. Nanoparticles of SiO₂ were then added into the solution to form a suspension. The suspension was cast onto a glass surface and heated to 75-80° C. to distill off toluene under a reduced pressure. In several samples, a garnet-type solid electrolyte (Li₇La₃Zr₂O₁₂ (LLZO) powder) was added into the reactive slurry to form polymer composite separator layers.

Molecular weight measurements indicate that the weight average molecular weight was 1.7×10⁴ and a step ladder polymer comprising 15 segments of the prepolymer hydrolytic condensates was formed. Further, the presence of the silanol group (Si—OH) was observed as the result of the infrared absorption spectroscopy.

The polymer composite layers were punched (pierced through) with sharp household needles to produce porous polymer composite layers having through-thickness holes. An anode, a porous polymer composite separator, and a. cathode layer were then stacked together and. encased by a protective housing to make a battery cell. A reactive mass including ether-based 1,3-dioxolane (DOL), 1,2-dimethoxyethane (DME) liquid electrolyte, lithium hexafluorophosphate (LiPF₆), and lithium bis(trifluoromethanesulfonyl)imide (LiTFSI) was injected into the battery cell. The precursor solution included 2 M LiPF₆ dissolved in a common DOL/DME liquid electrolyte, which contained 1 M LiTFSI) in a mixed organic solution of DOL and DME (1:1 , v/v). LiPF₆ is not only a lithium salt, but also an initiator for initiating the polymerization of DOL. The precursor solution residing in the pores was spontaneously transformed into quasi-solid electrolyte by standing for a period of time (2-24 hours) at room temperature.

For electrochemical testing, the working electrodes (cathode layers) were prepared by mixing 85 wt. % LiV₂O₅ or 88% of graphene-embraced LiV₂O₅ particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing Then, the electrodes were cut into a disk (ϕ=12 mm) and dried at 100° C. for 24 h in vacuum.

Electrochemical measurements were conducted on cells that were initially lithium metal-free and those cells that contained a lithium foil. In the former cells (anode-less cells), a polymer composite separator was sandwiched between a Cu foil and a cathode layer. The cell assembly was performed in an argon-filled glove-box. For comparison purposes, cells with the conventional Celgard 2400 membrane (porous PE-PP film) as a separator and was injected with an electrolyte solution containing 1 M LiPF₆ dissolved in a mixture of ethylene carbonate (EC) and diethyl carbonate (DEC) (EC-DEC, 1:1 v/v) were also tested. The CV measurements were carried out using a CH-6 electrochemical workstation at a scanning rate of 1-100 mV/s. The electrochemical performance of the cell featuring the polymer composite separator and that containing a conventional separator were evaluated by galvanostatic charge/discharge cycling at a current density of 50 mA/g using an Arbin electrochemical workstation.

The specific intercalation capacity curves of two lithium cells each having a cathode containing LiV₂O₅ particles (one cell having a thermally stable polymer-based separator and the other a conventional separator) were obtained and compared. As the number of cycles increases, the specific capacity of the conventional cells drops at a very fast rate. In contrast, the presently invented polymer composite-based solid electrolyte/separator provides the battery cell with a significantly more stable and high specific capacity for a large number of cycles. These data have demonstrated the surprising and superior performance of the presently invented high-temperature ladder polymer composite separator approach.

### EXAMPLE 11: POLYBENZOBISIMIDAZOLE (PBBI) RIGID-ROD/LADDER POLYMER-SOLID ELECTROLYTE COMPOSITE SEPARATORS

In a representative procedure, 1,2,4,5-Tetraminobenzene tetrahydrochloride (TABH) (4.0 g. 14.18 mmol) was dissolved in 77% polyphosphoric acid (PPA) (12 g). The 77% PPA was prepared by combining polyphosphoric acid and 85% phosphoric acid, The thus formed solution of TABH in PPA was placed in a glass reactor fitted with a mechanical stirrer, two gas ports and a side arm, The reaction vessel was purged with nitrogen for 20 minutes and thereupon maintained at a temperature of SOC under vacuum for 24 hours. After this treatment, complete dehydrochlorination occurred and the reaction mixture was cooled to 50° C. under a nitrogen atmosphere.

Subsequently, oxalic acid (1.277 g, 14.18 mmol) and phosphorus pentoxide (P₂O₅) (8 g). the P₂O₅ to compensate for the calculated water of condensation, were added to the dehydrochlorinated product. Nanoparticles of TiO₂ and Al₂O₃ were separately added into the reactive mass. The reaction temperature was raised to 120° C. and held at this temperature for 10 hours. The reaction temperature was thereupon raised to 140° C. and finally to a range of 180° to 200° C. The reaction was allowed to proceed in this elevated temperature range of 180° to 200° C. for 36 hours. The resultant product, a polymerization dope in PPA, was cast, roll-pressed to a desired thickness (25-30 μm), and cooled to room temperature. The product was thereupon purified by extraction of the PRA with water for three days. The resultant composite sheets were then needle-pierced to generate pores, which were impregnated with poly(ethylene glycol) diacrylate from a polymer solution.

### EXAMPLE 12: PREPARATION OF POLY(BENZOBISIMIDAZOLE VINYLENE) (PBIV)-BASED COMPOSITE SEPARATORS

TABH (5.2 g 18.3 mmol) was dehydrochlorinated in deaerated 77% (PPA) (16.5 g) accordance with the procedure utilized in Example 11. Upon complete dehydrochlorination, and under the conditions presented in Example 11, fumaric acid (2.125 g. 18.3 mmol) and P₂O₅ (12.2 g) were added. Nanoparticies of SiO₂ were added into the reactive mass. The reactive composite mass was cast over a stainless steel sheet surface and compressed into a sheet of desired thickness. The temperature was gradually raised to 120° C. over a period of six hours and then to 160° C. and finally to 180° C., This polymerization mixture, which became yellowish-brown in color, was allowed to proceed at 180° C. for 24 hours. The polymeric dope mixture was then purified by extraction in water for three days, producing a porous composite structure.

The porous sheet was impregnated with phenyl vinyl sulfone (PVS), which could be polymerized with several anionic-type initiators; e.g., n-BuLi, ZnEt2, LiN(CH₂)₂, and NaNH₂. The optional second solvent may be selected from pyridine, sulfolane, Trimethyl phosphate (TMP), Trifluoro-Phosphate (TFP), etc, Trimethyl phosphate has the following chemical structure:

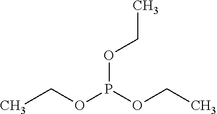

A mixture of PVS, TFP, n-BuLi (1.0% relative to PVS), and LiBF₄ (0.5 M) was thoroughly mixed and injected into the battery cell, which was maintained at 30° C. overnight to cure the polymer.

In conclusion, the flame/heat-resistant polymer composite-based separator strategy is surprisingly effective in alleviating the problems of lithium metal dendrite formation and lithium metal-electrolyte reactions that otherwise lead to rapid capacity decay and potentially internal shorting and explosion of the lithium secondary batteries. For lithium-ion cell application, these polymer composite electrolyte/separators perform very well as a safe solid-state electrolyte.

1. A flame-resistant composite separator for use in a lithium battery, wherein the composite separator comprises a porous layer of a first polymer, having pores and a thickness from 50 nm to 200 μm, and a second polymer permeating into or residing in said pores, wherein:
a) the first polymer comprises a flame-resistant polymer selected from the group consisting of epoxy, epoxy novolac, polyurethane, phenolic resin or phenol formaldehyde, polyester, vinyl ester resins, melamine resin, polyamide, polyamide-imide, bismaleimide, cyanate ester, silicone, polyurea-urethane, Diallyl-phthalate, benzoxazines, polyimide, poly(amide imide), poly(ether imide), aromatic polyamide, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1,3,4oxadiazoles), poly(1,2,4-oxa-diazoles), poly(1,2,4- and 1,2,5-oxadiazole-N-oxides), polythiadiazoes, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod polymers, ladder polymers, sulfonated versions thereof, copolymers thereof, interpenetrating networks thereof, and combinations thereof;
b) the second polymer comprises either a polymer that is obtained by in situ polymerizing and/or curing a reactive mass in the pores or a polymer solidified from a polymer solution inside the pores of the first polymer layer; and
c) the first polymer or the second polymer has a lithium-ion conductivity from 10⁻⁸ S/cm to 2×10⁻² S/cm at room temperature.

2. The flame-resistant composite separator of claim 1, wherein:
a) the first polymer further comprises 60%-99% by volume of inorganic material particles or fibers, 1-50% by weight of a lithium salt, and/or1-50% by weight of a flame-retardant additive dispersed or dissolved in the first polymer, and/or
b) the second polymer further comprises 60%-99% by volume of inorganic material particles or fibers, 1-50% by weight of a lithium salt, and/or 1-50% by weight of a flame-retardant additive dispersed or dissolved in the second polymer.

3. The flame-resistant composite separator of claim 2, wherein the inorganic material particles in the first polymer or the second polymer comprise an inorganic solid electrolyte material selected from an oxide type, sulfide type, hydride type, halide type, borate type, phosphate type, lithium phosphorus oxynitride (UPON) type, Garnet-type, lithium superionic conductor (LISICON) type, sodium superionic conductor (NASICON) type, or a combination thereof.

4. The flame-resistant composite separator of claim 2, wherein the inorganic material particles comprise a material selected from a transition metal oxide, aluminum oxide, silicon dioxide, transition metal sulfide, transition metal selenide, alkylated ceramic particles, metal phosphate, metal carbonate, or a combination thereof, or the inorganic material fibers are selected from ceramic fibers, glass fibers, or a combination thereof.

5. The flame-resistant composite separator of claim 1, wherein the second polymer is produced by polymerizing or curing the reactive mass comprising a polymerizable or curable first liquid solvent in the pores and the liquid solvent is selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, tetrahydrofuran, phosphates, phosphonates, phosphinates, phosphines, phosphinc oxides, phosphonic acids, phosphorous acid, phosphites, phosphoric acids, phospha.zene compounds, ionic liquids, derivatives thereof, and mixtures thereof.

6. The flame-resistant composite separator of claim 1, wherein the second polymer comprises a lithium ion-conducting polymer that is solidified from a polymer solution and is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

7. The flame-resistant composite separator of claim 1, wherein the lithium salt in the first polymer or the second polymer is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

8. The flame-resistant composite separator of claim 2, wherein the flame retardant additive is selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

9. The flame-resistant composite separator of claim 1, wherein the second polymer further comprises a second liquid solvent that permeates into the second polymer.

10. The flame-resistant composite separator of claim 9, wherein the second liquid solvent is selected from the group consisting of fluoroethylene carbonate, vinyl sulfite, vinyl ethylene sulfite, 1,3-propyl sultone, 1,3,5-trioxane (TXE), 1,3- acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, fluorinated vinyl esters, fluorinated vinyl ethers, sulfones, sulfides, dinitriles, acrylonitrile (AN), sulfates, siloxanes, silanes, N-methylacetamide, acrylates, ethylene glycols, tetrahydrofuran, phosphates, phosphonates, phosphinates, phosphines, phosphine oxides, phosphonic acids, phosphorous acid, phosphites, phosphoric acids, phosphazene compounds, ionic liquids, derivatives thereof, and mixtures thereof.

11. The flame-resistant composite separator of claim 10, wherein the second liquid solvent comprises a sulfone or sulfide selected from vinyl sulfone, allyl sulfone, alkyl vinyl sulfone, aryl vinyl sulfone, vinyl sulfide, TrMS, MTrMS, TMS, EMS, MMES, EMES, EMEES, or a combination thereof:

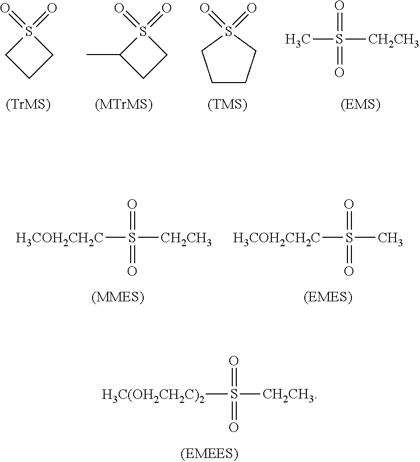

12. The flame-resistant composite separator of claim 11, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof.

13. The flame-resistant composite separator of claim 14, wherein the second liquid solvent comprises a nitrile, a dinitrile selected from AND, GLN, SEN, or succinonitrile, or a combination thereof wherein AND, GLN, and SEN, respectively, have the following chemical formula:

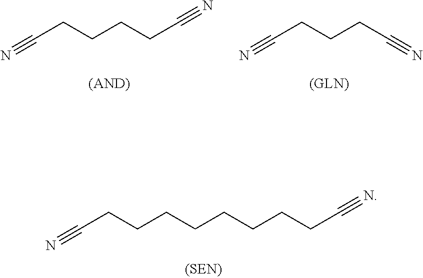 [SMILES: N#CCCCCC#N ; N#CCCCC#N ; N#CCCCCCCCCC#N]

14. The flame-resistant composite separator of claim 10, wherein the second liquid solvent comprises a phosphate selected from allyl-type, vinyl-type, styrenic-type and (meth)acrylic-type monomers bearing a phosphonate moiety.

15. The flame-resistant composite separator of claim 10, wherein the second liquid solvent is selected from the group consisting of 2-alkoxy (or phenoxy)-2-oxo-1,3,2-dioxaphospholane (I) and 2-alkoxy (or phenoxy)-2-oxo-1,3,2-dioxaphosphorinane (II), derivatives thereof, and combinations thereof:

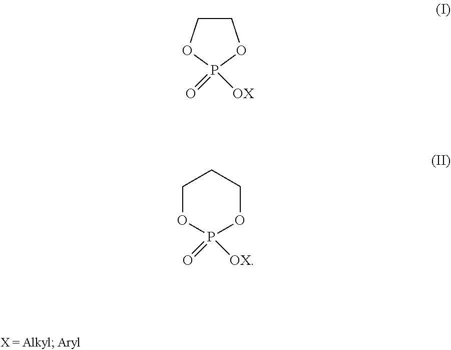

16. The flame-resistant composite separator of claim 10, wherein the second liquid solvent comprises phosphate, phosphonate, phosphonic acid, or phosphite selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, and DMMEMP have the following chemical formulae: 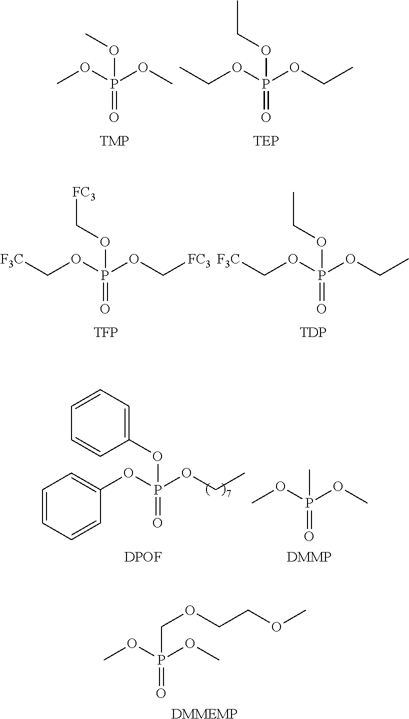
wherein an end group thereof or a functional group attached thereto comprises unsaturation for polymerization.

17. The flame-resistant composite separator of claim 10, wherein the second liquid solvent comprises phosphonate vinyl monomer selected from the group consisting of phosphonate bearing allyl monomers, phosphonate bearing vinyl monomers, phosphonate bearing styrenic monomers, phosphonate bearing (meth)acrylic monomers, vinylphosphonic acids, and combinations thereof.

18. The flame-resistant composite separator of claim 17, wherein the phosphonate bearing allyl monomer is selected from a Dialkyl allylphosphonate monomer or Dioxaphosphorinane allyl monomer; the phosphonate bearing vinyl monomers is selected from a Dialkyl vinyl phosphonate monomer or Dialkyl vinyl ether phosphonate monomer; the phosphonate bearing styrenic monomer is selected from α-, β-, or p-vinylbenzyl phosphonate monomers; or the phosphonate bearing (meth)acrylic monomer is selected from a monomer having a phosphonate group linked to the acrylate double bond, a phosphonate groups linked to the ester, or a phosphonate groups linked to the amide.

19. A lithium secondary battery comprising a cathode, an anode, the flame-resistant composite separator of claim 1 disposed between the cathode and the anode, and a protective housing or package .

20. The lithium secondary battery of claim 19, wherein the battery is a lithium metal battery and the anode has an anode current collector but initially the anode has no lithium or lithium alloy as an anode active material supported by said anode current collector when the battery is made and prior to a charge or discharge operation of the battery.

21. The lithium secondary battery of claim 19, wherein the battery is a lithium metal battery and the anode has an anode current collector and an amount of lithium or lithium alloy as an anode active material supported by said anode current collector.

22. The lithium secondary battery of claim 19, wherein the battery is a lithium-ion battery and the anode has an anode current collector and a layer of an anode active material supported by said anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

23. The lithium secondary battery of claim 19, wherein said battery further comprises, in addition to the solid electrolyte in the separator, a working electrolyte in ionic contact with an anode active material and/or a cathode active material wherein said working electrolyte is selected from an organic liquid electrolyte, ionic liquid electrolyte, polymer gel electrolyte, polymer solid electrolyte, solid-state inorganic electrolyte, quasi-solid electrolyte having a lithium salt dissolved in an organic or ionic liquid with a lithium salt concentration higher than 2.0 M, or a combination thereof.

24. The lithium secondary battery of claim 19, wherein the second polymer is also present in the anode or the cathode and the second polymer comprises a lithium salt dispersed therein.

25. The lithium secondary battery of claim 19, wherein said cathode comprises a cathode active material selected from an inorganic material, an organic material, a polymeric material, or a combination thereof.

26. The lithium secondary battery of claim 25, wherein said inorganic material, as a cathode active material, is selected from a metal oxide, metal phosphate, metal silicide, metal selenide, transition metal sulfide, metal fluoride, metal chloride, or a combination thereof.

27. The lithium secondary battery of claim 26, wherein said inorganic cathode active material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

28. The lithium secondary battery of claim 26, wherein said inorganic cathode active material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

29. The lithium secondary battery of claim 26, wherein said cathode active material is selected from lithium nickel manganese oxide (LiNiₐMn₂₋ₐO₄, 0<a<2), lithium nickel manganese cobalt oxide (LiNiₙMnₘCo_{1-n-,}O₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO4), lithium manganese oxide (LiMnO2), lithium cobalt oxide (LiCoO₂), lithium nickel cobalt oxide (LiNiₚCo₁₋ₚO₂, 0<p<1), or lithium nickel manganese oxide (LiNi₁Mn_{2-q}O₄, 0<q<2).

30. The lithium secondary battery of claim 26, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

31. A process for manufacturing the flame-resistant composite separator of claim 1, the process comprising:
a) providing a porous layer of the first polymer having pores comprising connected pores or through holes, pores that run through a thickness of the porous layer;
b) impregnating the pores or holes with a reactive mass or a polymer solution wherein the reactive mass comprises a monomer and an initiator or an oligomer and a curing agent, or wherein the polymer solution comprises the second polymer dissolved in a liquid solvent; and
c) forming the second polymer by in situ polymerizing and/or curing the reactive mass in the pores or by removing the solvent from the polymer solution to solidify or precipitate our the second polymer inside the pores of the first polymer layer.

32. The process of claim 31, wherein the reactive mass comprises a first solvent that is polymerizable or crosslinkable inside pores of the first polymer layer.

33. The process of claim 32, wherein the first solvent is selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, tetrahydrofuran, phosphates, phosphonates, phosphinates, phosphines, phosphine oxides, phosphonic acids, phosphorous acid, phosphites, phosphoric acids, phosphazene compounds, ionic liquids, derivatives thereof, and mixtures thereof.

34. The process of claim 31, wherein step (a) and step (b) are conducted inside a battery cell after the porous layer of the first polymer is combined with an anode and a cathode to form the cell.

35. The process of claim 33, further comprising a step (d) of impregnating a second liquid solvent, containing a lithium salt dispersed or dissolved therein, into the pores or holes of the porous first polymer layer.

36. The process of claim 31, comprising a roll-to-roll procedure wherein said step (a) and (b) comprise (i) continuously feeding a layer of said porous first polymer layer from a feeder roller to a dispensing zone where the reactive mass or the polymer solution is dispensed and deposited onto said porous first polymer layer, allowing the reactive mass or the polymer solution to permeate into the pores; and step (c) comprises (ii) moving the reactive mass-or polymer solution-impregnated porous polymer layer into a reacting zone or solidification zone where the reactive mass is exposed to heat, ultraviolet light, or high-energy radiation to initiate the polymerization or curing procedure, or wherein the solvent in the polymer solution is removed, to form a continuous layer of polymer composite comprising both the first polymer and the second polymer; and wherein the process further comprises (iii) collecting said polymer composite on a winding roller.

37. The process of claim 36, further comprising cutting and trimming said layer of polymer composite into one or multiple pieces of polymer composite separators.

38. The process of claim 37, further comprising a step of combining an anode, said polymer composite separator, an electrolyte, and a cathode electrode to form a lithium battery.
